(19) United States
(12) Patent Application Publication
(10) Pub. No.: US 2010/0138290 A1
(43) Pub. Date: Jun. 3, 2010

(54) System and Method for Auctioning Avails

(75) Inventors: Mark S. Zschocke, Kitchener (CA); Daniel C. Wilson, Edmonton (CA)

Correspondence Address: MARSH, FISCHMANN & BREYFOGLE LLP, 8055 East Tufts Avenue, Suite 450, Denver, CO, 80237, US

(73) Assignee: INVIDI TECHNOLOGIES CORPORATION, Princeton, NJ (US)

(21) Appl. No.: 12/697,842

(22) Filed: Feb. 1, 2010

Related U.S. Application Data
(63) Continuation-in-part of application No. 11/761,965, filed on Jun. 12, 2007.
(60) Provisional application No. 61/148,807, filed on Jan. 30, 2009.
(60) Provisional application No. 60/804,459, filed on Jun. 12, 2006.

(51) Int. Cl. G06Q 30/00; G06Q 10/00

(52) U.S. Cl. 705/14.41; 705/14.46; 705/14.52; 705/14.71

(57) ABSTRACT

A system and method is provided for use in connection with auctioning delivery spots (e.g., ad spots) or commercial impressions in a broadcast network. The system provides (1702) information regarding asset delivery spots and receives (1704) bids from asset providers. A winning bidder is determined (1706), and a corresponding asset is delivered (1708) via the broadcast network.

### CROSS-REFERENCE

This application claims priority under 35 U.S.C. 119 to U.S. Provisional Application No. 61/148,807, entitled, “SYSTEM AND METHOD FOR AUCTIONING AVAILS,” filed on Jan. 30, 2009, the contents of which are incorporated herein as if set forth in full. In addition, this application is a continuation-in-part to U.S. patent application Ser. No. 11/761,965, entitled “SYSTEM AND METHOD FOR AUCTIONING AVAILS,” filed on Jun. 12, 2007, which claims priority under 35 U.S.C. §119 to U.S. Provisional Application No. 60/804,459, entitled “ADVATAR AND AUCTIONS,” filed on Jun. 12, 2006, the contents of both of which are incorporated by reference herein as if set forth in full.

### FIELD

Systems and methods presented herein relate to the provision of targeted assets via a network interface. In one specific arrangement, targeted advertising media delivery opportunities are auctioned to asset providers (e.g., advertisers).

### BACKGROUND

Broadcast network content or programming is commonly provided in conjunction with associated informational content or assets. These assets include advertisements, associated programming, public-service announcements, ad tags, crawls, weather or emergency notifications and a variety of other content, including paid and unpaid content. In this regard, asset providers (e.g., advertisers) who wish to convey information (e.g., advertisements) regarding services and/or products to users of the broadcast network often pay for the right to insert their information into programming of the broadcast network. For instance, advertisers may provide ad content to a network operator such that the ad content may be interleaved with broadcast network programming during one or more programming breaks. The delivery of such paid assets often subsidizes or covers the costs of the programming provided by the broadcast network. This may reduce or eliminate costs borne by the users of the broadcast network programming.

In order to achieve a better return on their investment, asset providers often try to target their assets to a selected audience that is believed to be interested in the goods or services of the asset provider. The case of advertisers on a cable television network is illustrative. For instance, an advertiser or a cable television network may desire to target its ads to certain demographic groups based on, for example, geographic location, gender, age, income, lifestyle, interests and the like. Accordingly, once an advertiser has created an ad that is targeted to a desired group of viewers (e.g., a target segment of an aggregate audience) the advertiser may attempt to procure insertion times in the network programming when the target segment is expected to be among the audience of the network programming.

Target segments from several asset providers may overlap. In other words, target users among the aggregate audience may belong to more than one target segment. For instance, a 35-year-old female may fall into multiple target segments, e.g., a segment targeting women, a segment targeting adults over 30 years old and, perhaps, a segment targeting pet owners and/or a segment targeting a particular income bracket. In this regard, several asset opportunities may exist for any given segment of the aggregate audience.

Conventionally, asset delivery opportunities (such as ad spots in a television commercial break) have been sold to a single asset provider (such as a specific advertiser). That is, because of the broadcast nature of such networks, only a single asset has typically been provided in connection with a given spot in a given network subdivision. Asset providers have therefore sought to place their assets in spots associated with programming having a significant audience segment matching the targeting parameters (e.g., demographics) for the asset. One common way of pricing asset delivery has been the product of a cost that the asset provider has agreed to pay per thousand audience members (CPM) and the size of the audience segment that matches the asset targeting parameters. In such cases, no revenues are generated in connection with other audience segments.

The emergence of targeted asset delivery in broadcast networks has provided the opportunity to target different market segments and to generate revenues associated with multiple segments. In a simple implementation, an asset delivery option associated with each audience segment can be sold separately and priced by conventional mechanisms. However, as granularity of targeting audience segments becomes more fine, individual audience members will increasingly fall into multiple audience segments, and the ability to neatly de-convolve the audience into separate delivery options within a single asset delivery opportunity (i.e., spot) become more complex, as do efforts to determine how to maximize revenues. Moreover, when it is desired to sell such opportunities just-in-time so as to take advantage of near real-time feedback regarding current audience size and composition, the problem of optimizing asset placement and optimizing revenues becomes seemingly intractable, at least when considered in relation to conventional delivery contract models.

### SUMMARY

The inventors of the present application have recognized that systems that allow for obtaining information regarding current network users and/or the ability to dynamically insert assets (e.g., ad content) into one or more content streams may allow asset providers to more effectively match their assets to targeted network users. The inventors have also recognized that the ability to, inter alia, obtain current information and/or dynamically insert assets into one or more content streams of a broadcast network may facilitate additional functionalities for targeted advertising. Moreover, as technologies are developed for targeting audience segments with finer granularity, traditional Nielsen-like audience segmentation becomes less satisfactory as a mechanism for pricing and selling asset delivery. In this regard, methods and apparatuses are provided for auctioning assets for target users of a broadcast network, and specifically, to determine one or more winning bids and payments to be made in connection with each winning bid in a manner that maximizes revenue and/or meet other business goals of the seller while providing significant value to each winning asset provider. Such auctioning may be done interactively prior to specific avails and/or in an automated process.

The inventors have further recognized that auctioning asset delivery options for delivering assets to target users of a broadcast network yields several benefits. First, auctioning addresses the complications associated with dynamically targeting assets to different, but overlapping segments of an aggregate audience because individual user impressions may be auctioned separately. In addition, auctioning is efficient in that the asset provider that most values an asset delivery option receives that option through the auctioning process. Moreover, an appropriate auctioning model may be selected to optimize the auction results to meet one or more goals when considered in light of an applicable auctioning environment (e.g., number of bidders, number of users, variance of bids, bidder sophistication, etc.). For example, auctioning may be used to maximize revenue for a seller, as well as to meet legal and/or contractual requirements and accommodate or address policy and/or business concerns.

Auctioning asset delivery options also improves seller flexibility. For instance, in contrast to conventional sale and pricing schemes associated with the sale of assets, the seller need not provide any type of user-impression guarantee to bidding asset providers. That is, under conventional schemes, asset providers agree to pay a certain price for a specified number of user impressions available in an asset delivery spot. Thus, a conventional system must accommodate situations in which, ultimately, the supply of user impressions does not meet the demand, and as a result, the asset provider does not receive the number of user impressions specified. In these circumstances, the asset provider may receive a partial refund or a rebate on a next asset delivery purchase. Auctioning asset delivery options avoids these inefficiencies because the price resolves at a point at which the supply meets the demand.

Turning to a first aspect of the present invention, targeted asset delivery methodology includes a system and method (“utility”) for auctioning asset delivery options in a broadcast network that primarily involves the synchronized distribution of broadcast content to an aggregate audience of target users. The utility includes a traffic interface for receiving information regarding the aggregate audience. Such information includes one or more classification parameters associated with each target user, and each classification parameter identifies a segment of the aggregate audience. The utility also includes a user interface for receiving, from each of several asset providers, an identification of at least one asset for distribution within the broadcast network, one or more targeting parameters associated with each asset, and a value or bid per user impression for one or more of the segments of the aggregate audience. In addition, the utility includes a processor having logic for determining, from a set of defined auctioning models, respective first and second auctioning models for auctioning first and second asset delivery options. The logic is also configured for auctioning the first and second asset delivery options via the first and second auctioning models, respectively.

Notably, the utility may be used to auction any appropriate number of asset delivery options via any appropriate number of auctioning models. Two parallel asset delivery options auctioned via two exemplary auctioning models are described merely for ease in explanation. Further, the selected auctioning models may be the same or different, and auctioning the first asset delivery option via the first auctioning model and/or the second asset delivery option via the second auctioning model may result in a maximum revenue for a seller. Alternatively, and as discussed above, the selected auctioning models may result in meeting other or additional seller goals, such as legal, contractual, business, or policy requirements or agreements.

In one embodiment, the first and second auctioning models may be determined using one or more of a variety of environmental auctioning factors. These factors may include, for example, a number of assets competing for the first and second asset delivery options (i.e., the demand for asset delivery options), a size of the aggregate audience, a number of available asset delivery options, a variance between the values or bids per impression, a time required to execute the auction, an ease with which the auctioning model can be explained to asset providers, and an identity of one or more of the asset providers.

In analyzing the environmental auctioning factors to determine the first and second auctioning models, a first subset of factors may be used to determine the first auctioning model and a second subset of factors may be used to determine the second auctioning model. These subsets may be the same or different and may each include one or more of the environmental auctioning factors. Moreover, the factors may be analyzed iteratively, or analyzed prior to each separate auction. That is, the first subset of environmental auctioning factors may be analyzed to determine the first auctioning model before a first winning asset is determined via a first auction that implements the first auctioning model. Thereafter, the target users that are captured by the first winning asset may be removed from the aggregate audience before the second set of environmental auctioning factors is analyzed to determine the second auctioning model. In this regard, any changes within the auctioning environment (i.e., to the environmental auctioning factors) that result from a winning asset being removed from the aggregate audience (e.g., change in demand, change in value variance, change in audience size, etc.) may factor into the determination of the second auctioning model.

In another embodiment, and prior to determining the first and/or second auctioning models, one or more asset delivery constraints may be analyzed in constructing a pool or list of assets that is available for delivery. Any auction following this determination may be restricted or limited to the asset included in the pool. The asset delivery constraints may include legal constraints such as statutes or regulations that regulate the content and or timing of certain assets, and they may also be contractual constraints, business constraints, policy constraints, or any other appropriate criteria that may be used to limit the asset pool.

Another aspect of the present invention involves a utility for use with a computer-based system for auctioning asset delivery options in a broadcast network that generally involves synchronized distribution of broadcast content to multiple target users. The utility includes identifying first and second asset delivery options for delivering content. The first and second asset delivery options are part of a single asset delivery opportunity. The utility also involves providing information regarding the first and second asset delivery options to one or more asset providers and receiving, from the asset providers, bids associated with the first and second asset delivery options. Once the bids have been received, the utility involves executing logic in connection with the computer-based auctioning system for (1) determining, from a set of defined auctioning models, first and second auctioning models for auctioning first and second asset delivery options, and (2) auctioning the first and second asset delivery options using the first and second auctioning models, respectively.

A further aspect of the present invention involves a utility for use with a computer-based system for auctioning assets to target users of a broadcast network involving the synchronized distribution of broadcast content. The utility includes providing information regarding one or more asset delivery options for delivering content to the aggregate audience, where the aggregate audience includes a number of at least partially overlapping segments. The utility also involves receiving bids associated with the asset delivery options from one or more asset providers, where each of the bids includes a value per impression for one of the segments of the aggregate audience. In addition, the utility involves running a sub-auction for each of a plurality of factions within the aggregate audience, where each faction comprises a smaller fractional portion of the aggregate audience than does each of the segments, and determining a winning bid that is based on a collective outcome of each of the sub-auctions. The utility concludes with selecting an asset associated with the winning bid for insertion into a content stream of the broadcast network for delivery during the asset delivery option.

In one implementation, each of the segments of the aggregate audience may be based on one or more audience characteristics such as, for example, age, gender, ethnicity, income, geographic locale, or any other appropriate characteristic, and each of the factions may include one of the target users within the aggregate audience. The audience characteristics may be gathered from third-party data repositories such as, for example, credit reporting agencies that collect and maintain audience information relating to hundreds of audience characteristics.

In another embodiment, the utility may involve determining a sub-winning bid for each of the sub-auctions. The winning bid may be based on a maximum total of the sub-winning bids from each of the asset providers. After the winning bid is determined, the utility may include determining a payment to be made in connection with the winning bid before removing each of the factions encompassed within the winning bid from the aggregate audience and repeating the steps of running the sub-auctions, determining the winning bid, determining the payment to be made in connection with the winning bid, selecting the asset associated with the winning bid for insertion into the content stream, and removing each of the factions encompassed within the winning bid until a final asset is selected for insertion into the content stream. In this regard, the present invention may include an iterative process for selecting winning bids for respective audience segments that is repeated until no asset delivery opportunities remain. In addition, each time the process is repeated, the winning bid and the payment to be made in connection with the winning bid may be determined according to a different auctioning model, such that both the seller's revenue and the asset provider's value are maximized.

In an additional embodiment, the payment to be made in connection with the winning bid may be based at least in part on one or more non-winning bids and a measurement of a size of the aggregate audience. For instance, in one embodiment, the payment may be based in part on an amount that one or more non-winning asset providers are willing to pay to have the winning bid. In another embodiment, the payment may be based at least in part on the greatest of (1) a minimum total that a winning asset provider must pay to retain the winning bid, and (2) a maximum total that a first non-winning asset provider is willing to pay to replace the winning bid. In yet another implementation, the payment may be based in part on a minimum of a minimum total that a winning asset provider must pay to retain the winning bid and a total offering price of the winning asset provider. In an additional embodiment, the payment may be required to be at least equal to a reservation price. Notably, both the winning bid and the payment associated with the winning bid for the final asset may be made according to a revised auction model that differs from that used to determine the previous winning bids and corresponding payments.

An additional aspect of the present invention involves another utility for use with a computer-based system for auctioning assets to target users of a broadcast network that primarily involves the synchronized distribution of broadcast content to an aggregate audience of target users. The synchronized distribution may be accomplished using various system architectures, including, for example, forwarding both a programming stream and an asset delivery stream to a user equipment device (UED) equipped with designated storage space (e.g., a DVR). The asset delivery stream may include the assets along with identifying metadata. In this implementation, the assets may be stored within the designated storage space for later selection and insertion by the UED during a break in scheduled programming. Another architecture for synchronized distribution may involve a channel-hopping functionality, in which several asset options may be transmitted synchronously within a given break in programming. The UED may be operative to switch to an asset channel associated with a desired asset at the beginning of a break and return to the programming channel at the end of the break. In a further synchronized distribution architecture, a determination regarding which asset to show may be made at a remote platform and inserted directly into the programming channel being viewed at the UED.

More specifically, the utility includes providing information regarding one or more asset delivery options for delivering content to the aggregate audience, where the aggregate audience comprises a number of at least partially overlapping segments. The utility also involves receiving bids associated with the asset delivery options from one or more asset providers. Each bid includes a value per impression for one of the segments of the aggregate audience. The utility further includes determining a winning bid from among the bids and determining a payment to be made in connection with the winning bid. The payment is based at least in part on one or more non-winning bids and a measurement of a size of at least a portion of an audience segment.

In one embodiment, the payment may be based on a number of user impressions that the winning bid garners or takes away from one or more non-winning bids. In another embodiment, the payment may be based at least in part on an amount that one or more non-winning asset providers are willing to pay to have the winning bid.

In another implementation, the utility further includes removing each of the impressions encompassed within the winning bid from the aggregate audience and repeating the steps of determining the winning bid, determining the payment to be made in connection with the winning bid, and removing each of the impressions encompassed within the winning bid until a final asset is selected for insertion into the content stream of the broadcast network.

Yet another aspect of the present invention involves a utility for use with a computer-based system for auctioning assets to target users within an aggregate audience of a broadcast network. The utility includes providing information regarding first and second asset delivery options for delivering content to the aggregate audience, where the aggregate audience includes a plurality of at least partially overlapping segments. The utility also includes receiving, from one or more asset providers, bids associated with the first and second asset delivery options, where each bid includes a value per impression for one of the segments of the aggregate audience. In addition, the utility involves determining, from among the bids, a first winning bid for the first asset delivery option and a second winning bid for the second asset delivery option and determining first and second payments to be made in connection with the first and second winning bids, respectively. The first payment is based at least in part on an amount that any of the asset providers is willing to pay to have the first winning bid and an amount that one or more non-winning asset providers are willing to pay to have one of the first and second bids. The second payment may be based at least in part on an amount that any of the asset providers is willing to pay to have the second winning bid and an amount that one or more of the non-winning asset providers are willing to pay to have one of the first and second winning bids.

An additional aspect of the present invention involves a utility for use with a computer-based system for auctioning assets to target users of a broadcast network involving synchronized distribution of broadcast content to an aggregate audience of target users. The utility includes receiving a first bid for a first segment of the aggregate audience and receiving a second bid for a second segment of the aggregate audience. The first and second segments each include one or more overlapping portions of the aggregate audience. The utility also includes considering the overlapping portions to determine a winning bid and a payment to be made in connection with the winning bid that maximizes revenue.

As presented, the present invention entails a novel utility for auctioning asset delivery options that accounts for the competition landscape and overlapping/dynamically changing auction environment that is characteristic of the broadcast network asset delivery environment. In some instances, the utility involves resolving segment overlaps and pricing based on non-winning bids with respect to identified overlaps.

### BRIEF DESCRIPTION OF THE DRAWINGS

FIG. 1 illustrates major components of a cable television network.

FIG. 2 illustrates bandwidth usage that is dynamically determined on a geographically dependent basis via networks.

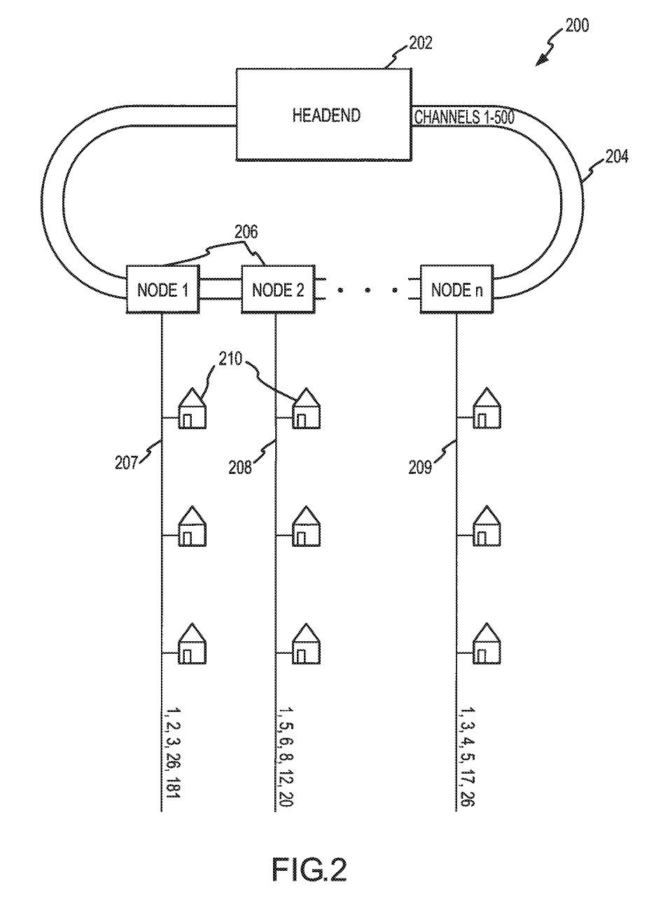

FIG. 3 illustrates asset insertion as accomplished at a headend.

FIG. 4 illustrates exemplary audience shares of various networks as may be used to set asset delivery prices for future breaks associated with the program.

FIG. 5 illustrates delivery of assets to different users watching the same programming channel.

FIG. 6 illustrates audience aggregation across.

FIG. 7 illustrates a virtual channel in the context of audience aggregation.

FIG. 8 illustrates targeted asset insertion being implemented at Customer Premises Equipment or User Equipment Devices (UEDs).

FIG. 9 illustrates asset options being transmitted from a headend on separate asset channels.

FIG. 10 illustrates a messaging sequence between a UED, a network platform, and a traffic and billing (T&B) system.

FIG. 11 is a flow chart illustrating a process for implementing time-slot and targeted impression buys.

FIG. 12 illustrates exemplary sequences associated with breaks on programming channels.

FIG. 13 illustrates an application that is supported by signals from UEDs and which provides targeted assets to users of one or more channels within a network.

FIG. 14 illustrates the use of asset channels for providing assets during a break of a programming channel.

FIG. 15 illustrates a reporting system.

FIG. 16 illustrates an auctioning platform incorporated into a targeted asset system.

FIG. 17 is a flow chart illustrating a first auction technique.

FIG. 18 is a flow chart illustrating a second auction technique.

FIG. 19 is a flow chart illustrating a third auction technique.

### DETAILED DESCRIPTION

The description relates to various structure and functionality for delivery of targeted assets, classification of network users or consuming patterns, and network monitoring for use in a communications network, as well as associated business methods (collectively a “targeted asset delivery system” or “asset targeting system”). The targeted asset delivery system is applicable with respect to networks where content is broadcast to network users; that is, the content is made available via the network to multiple users without being specifically addressed to individual user nodes in point-to-point fashion. In this regard, content may be broadcast in a variety of networks including, for example, cable and satellite television networks, satellite radio networks, IP networks used for multicasting content and networks used for podcasts or telephony broadcasts/multicasts. Content may also be broadcast over the airwaves though, as will be understood from the description below, certain aspects of the invention make use of bi-directional communication channels which are not readily available, for example, in connection with conventional airwave based televisions or radios (i.e., such communication would involve supplemental communication systems). In various contexts, the content may be consumed in real time or stored for subsequent consumption. Thus, while specific examples are provided below in the context of a cable television network for purposes of illustration, it will be appreciated that the invention is not limited to such contexts but, rather, has application to a variety of networks and transmission modes. In addition, while the following description focuses on implementing the system at one network operator or multiple systems operator (“MSO”), the system could also be implemented as part of a centralized administrator or clearinghouse that communicates with each of the network operators in a layered format. That is, the system may be applied in a two-layer system of purchasing in which the centralized administrator manages the sale of asset delivery options on behalf of each system operator or, alternatively, acts as a proxy for asset providers in bidding on asset delivery options being sold by individual network operators.

The targeted assets may include any type of asset that is desired to be targeted to network users. For example, targeted assets may include advertisements, internal marketing (e.g., information about network promotions, scheduling or upcoming events), public service announcements, weather or emergency information, or programming. Such targeted assets are sometimes referred to as “addressable” assets (though, as will be understood from the description below, targeting can be accomplished without addressing in a point-to-point sense). The targeted assets may be independent or included in a content stream with other assets such as untargeted network programming. In the latter case, the targeted assets may be interspersed with untargeted programming (e.g., provided during programming breaks) or may otherwise be combined with the programming as by being superimposed on a screen portion in the case of video programming. In the description below, specific examples are provided in the context of targeted assets provided during breaks in television programming. While this is an important commercial implementation of the invention, it will be appreciated that the invention has broader application. Thus, distinctions below between “programming” and “assets” such as advertising should not be understood as limiting the types of content that may be targeted or the contexts in which such content may be provided.

The following description is divided into a number of sections. In the Introduction section, the broadcast network and network programming environments are first described. Thereafter, an overview of the targeted asset environment is provided including a discussion of certain shortcomings of the conventional asset delivery paradigm. The succeeding section describes components of a targeted asset delivery system, highlighting advantages of certain implementations thereof. Finally, the last section describes various structure and functionality for implementing auctioning of delivery spots and/or commercial impressions.

### I. Introduction

A. Broadcast Networks

The present invention has particular application in the context of networks primarily used to provide broadcast content, herein termed broadcast networks. Such broadcast networks generally involve synchronized distribution of broadcast content to multiple users. However, it will be appreciated that certain broadcast networks are not limited to synchronously pushing content to multiple users but can also be used to deliver content to specific users, including on a user pulled basis. As noted above, examples of broadcast networks include cable television networks, satellite television networks, and satellite radio networks. In addition, audio, video or other content may be broadcast across Internet protocol and telephony networks. In any such networks, it may be desired to insert targeted assets such as advertisements into a broadcast stream. Examples of broadcast networks used to deliver content to specific users include broadcast networks used to deliver on demand content such as VOD and podcasts. The targeted asset delivery system provides a variety of functionality in this regard, as will be discussed in detail below.

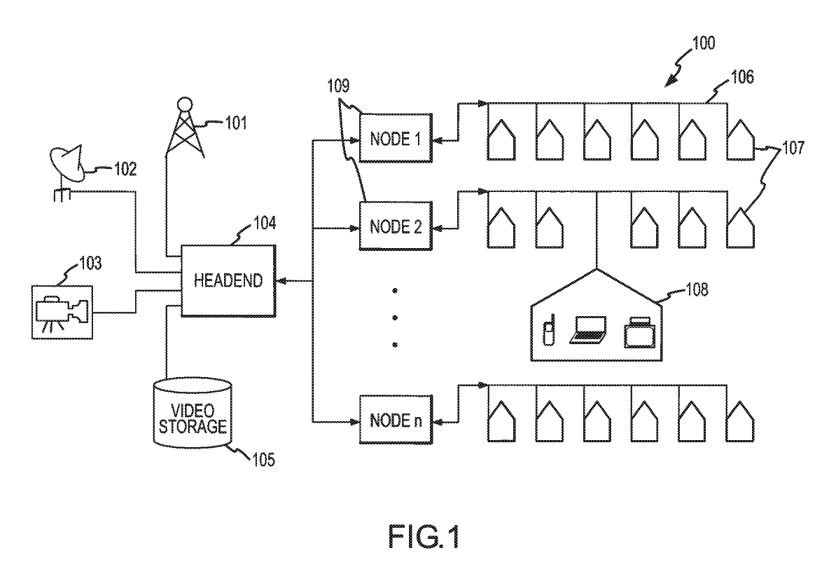

For purposes of illustration, embodiments of the targeted asset delivery system are described in some instances below in the context of a cable television network implementation. Some major components of a cable television network 100 are depicted in FIG. 1. In the illustrated network 100, a headend 104 obtains broadcast content from any of a number of sources 101-103. Additionally, broadcast content may be obtained from storage media 105 such as via a video server. The illustrated sources include an antenna 101, for example, for receiving content via the airwaves, a satellite dish 102 for receiving content via satellite communications, and a fiber link 103 for receiving content directly from studios or other content sources. It will be appreciated that the illustrated sources 101-103 and 105 are provided for purposes of illustration and other sources may be utilized.

The headend 104 processes the received content for transmission to network users. Among other things, the headend 104 may be operative to amplify, convert and otherwise process the broadcast content signals as well as to combine the signals into a common cable for transmission to network users 107 (although graphically depicted as households, as described below, the system of the present invention can be used in implementations where individual users in a household are targeted). It also is not necessary that the target audience be composed households or household members in any sense. For example, the present invention can be used to create on-the-fly customized presentations to students in distributed classrooms, e.g., thus providing examples which are more relevant to each student or group of students within a presentation being broadcast to a wide range of students. The headend also processes signals from users in a variety of contexts as described below. The headend 104 may thus be thought of as the control center or local control center of the cable television network 100.

Typically, there is not a direct fiber link from the headend 104 to a user equipment device (UED) 108. Rather, this connection generally involves a system of feeder cables and drop cables that define a number of system subsections or branches. This distribution network may include a number of nodes 1091-N. The signal may be processed at these nodes 1091-N to insert localized content, filter the locally available channels or otherwise control the content delivered to users in the node area. The resulting content within a node area is typically distributed by optical and/or coaxial links 106 to the premises of particular users 107. Finally, the broadcast signal is processed by the UED 108 which may include a television, data terminal, a digital set top box, DVR or other terminal equipment. It will be appreciated that digital or analog signals may be involved in this regard.

Users employ the network, and network operators derive revenue, based on delivery of desirable content or programming. The stakeholders in this regard include programming providers, asset providers such as advertisers (who may be the same as or different than the programming providers), network operators such as Multiple Systems Operators (MSOs), and users—or viewers in the case of television networks. Programming providers include, for example: networks who provide series and other programming, including on a national or international basis; local affiliates who often provide local or regional programming; studios who create and market content including movies, documentaries and the like; and a variety of other content owners or providers. Asset providers include a wide variety of manufacturers, retailers, service providers and public interest groups interested in, and generally willing to pay for, the opportunity to deliver messages to users on a local, regional, national or international level. As discussed below, such assets include: conventional advertisements; tag content such as ad tags (which may include static graphic overlays, animated graphics files or even real-time video and audio) associated with the advertisements or other content; banners or other content superimposed on or otherwise overlapping programming; product placement; and other advertising mechanisms. In addition, the networks may use insertion spots for internal marketing as discussed above, and the spots may be used for public service announcements or other non-advertising content. Network operators are generally responsible for delivering content to users and otherwise operating the networks as well as for contracting with the networks and asset providers and billing. Users are the end consumers of the content. Users may employ a variety of types of UEDs including televisions, set top boxes, iPOD™ devices, data terminals, satellite delivered video or audio to an automobile, appliances (such as refrigerators) with built-in televisions, etc.

As described below, all of these stakeholders have an interest in improved delivery of content including targeted asset delivery. For example, users can thereby be exposed to assets that are more likely of interest and can continue to have the costs of programming subsidized or wholly borne by asset providers. Asset providers can benefit from more effective asset delivery and greater return on their investment. Network operators and asset providers can benefit from increased value of the network as an asset delivery mechanism and, thus, potentially enhanced revenues. The present invention addresses all of these interests.

It is sometimes unclear that the interests of all of these stakeholders are aligned. For example, it may not be obvious to all users that they benefit by consuming such assets. Indeed, some users may be willing to avoid consuming such assets even with an understanding of the associated costs. Network operators and asset providers may also disagree as to how programming should best be distributed, how asset delivery may be associated with the programming, and how revenues should be shared. As described below, the targeted asset delivery system provides a mechanism for accommodating potentially conflicting interests or for enhancing overall value such that the interests of all stakeholders can be advanced.

Assets can be provided via a variety of distribution modes including real-time broadcast distribution, forward-and-store, channel hopping, remote delivery of assets into the selected scheduled network programming, on-demand delivery such as VOD, or any combination of these alternatives. Real-time broadcast delivery involves synchronous delivery of assets to multiple users such as the conventional paradigm for broadcast radio or television (e.g., airwave, cable or satellite). The forward-and-store mode involves delivery of assets ahead of time to UEDs with substantial storage resources, e.g., a DVR or data terminal. The asset is stored for later display, for example, as prompted by the user or controlled according to logic resident at the UED and/or elsewhere in the communications network. The channel hopping mode involves transmitting assets via a bandwidth separate from that of the programming (e.g., via a separate dedicated asset channel) and using architecture present at the UED to switch to an asset channel associated with a desired asset at the beginning of a break and to return to the programming channel at the end of the break. The remote delivery mode involves remotely determining a desired asset for the UED from the headend or another remote platform and inserting the selected asset into a programming content stream to be unicast to the UED or multicast to a group of UEDs to receive the same asset. The on-demand mode involves individualized delivery of assets from the network to a user, often on a pay-per-view basis. The present invention can be utilized in connection with any of these distribution modes or others. In this regard, important features of the present invention can be implemented using conventional UEDs without requiring substantial storage resources to enhance even real-time broadcast programming, for analog and digital users.

The amount of programming that can be delivered to users is limited by the available programming space. This, in turn, is a function of bandwidth. Thus, for example, cable television networks, satellite television networks, satellite radio networks, and other networks have certain bandwidth limitations. In certain broadcast networks, the available bandwidth may be divided into bandwidth portions that are used to transmit the programming for individual channels or stations. In addition, a portion of the available bandwidth may be utilized for bi-directional messaging, metadata transmissions and other network overhead. Alternately, such bi-directional communication may be accommodated by any appropriate communications channels, including the use of one or more separate communications networks. The noted bandwidth portions may be defined by dedicated segments, e.g., defined by frequency ranges, or may be dynamically configured, for example, in the case of packetized data networks. As described below, one implementation of the asset targeting system uses available (dedicated or opportunistically available) bandwidth for substantially real time transmission of assets, e.g., for targeted asset delivery with respect to a defined asset delivery spot. In this implementation, bi-directional communications may be accommodated by dedicated messaging bandwidth and by encoding messages within bandwidth used for asset delivery. A DOCSIS path or certain TELCO solutions using switched IP may be utilized for bi-directional communications between the headend and UEDs and asset delivery to the UEDs, including real-time asset delivery, in the systems described below.

B. Scheduling

What programming is available on particular channels or other bandwidth segments at particular times is determined by scheduling. Thus, in the context of a broadcast television network, individual programming networks, associated with particular programming channels, will generally develop a programming schedule well into the future, e.g., weeks or months in advance. This programming schedule is generally published to users so that users can find programs of interest. In addition, this programming schedule is used by asset providers to select desired asset delivery spots.

Asset delivery is also scheduled. That is, breaks are typically built into or otherwise provided in programming content. In the case of recorded content, the breaks are pre-defined. Even in the case of live broadcasts, breaks are built-in. Thus, the number and duration of breaks is typically known in advance, though the exact timing of the breaks may vary to some extent. There are, however, some exceptions to this general practice. For example, if sporting events go into overtime, the number, duration and timing of breaks may vary dynamically. As discussed below, the asset targeting system can handle real-time delivery of assets for updated breaks. In connection with regularly scheduled breaks, as discussed below, defined avail windows establish the time period during which certain breaks or spots occur, and a cue tone or cue message signals the beginning of such breaks or spots. In practice, an avail window may be as long as or longer than a program and include all associated breaks. Indeed, avail windows may be several hours long, for example, in cases where audience demographics are not expected to change significantly over large programming blocks. In this regard, an MSO may merge multiple avail windows provided by programming networks.

More specifically, a break may include a series of asset delivery spots and the content of a break may be determined by a number of entities. For example, some asset delivery is distributed on a basis coextensive with network programming, e.g., on a national basis. This asset delivery is conventionally scheduled based on a timed playlist. That is, the insertion of content is centrally controlled to insert assets at defined times. Accordingly, the programming and national asset delivery may be provided by the programming networks as a continuous content stream without cues for asset insertion. For example, prime-time programming on the major networks is often principally provided in this fashion.

In other cases, individual spots within a break are allocated for Regional Operations Center (ROC), affiliate, super headend or local (headend, zone) content. In these cases, a cue tone or message identifies the start of the asset delivery spot or spots (a series of assets in a break may all trigger from one cue). The cue generally occurs a few seconds before the start of the asset delivery insertion opportunity and may occur, for example, during programming or during the break (e.g., during a national ad). The system of the present invention can be implemented at any or all levels of this hierarchy to allow for targeting with respect to national, regional and local assets. In the case of regional or local targeted asset delivery, synchronous asset options (as discussed below) may be inserted into designated bandwidth in response to cues. In the case of national asset delivery, network signaling may be extended to provide signals identifying the start of a national spot or spots, so as to enable the inventive system to insert synchronous national asset options into designated bandwidth. For example, such signaling may be encrypted for use only by the targeted asset delivery system.

Network operators or local network affiliates can generally schedule the non-national assets to be included within defined breaks or spots for each ad-supported channel. Conventionally, this scheduling is finalized ahead of time, typically on a daily or longer basis. The scheduled assets for a given break are then typically inserted at the headend in response to the cue tone or message in the programming stream. Thus, for example, where a given avail window includes three breaks (each of which may include a series of spots), the scheduled asset for the first break is inserted in response to the first cue, the scheduled asset for the second break is inserted in response to the second cue, and the scheduled asset for the third break is inserted in response to the third cue. If a cue is missed, all subsequent assets within an avail window may be thrown off.

It will be appreciated that such static, daily scheduling can be problematic. For example, the programming schedule can often change due to breaking news, ripple effects from schedule over-runs earlier in the day or the nature of the programming. For example, certain live events such as sporting events are difficult to precisely schedule. In such cases, static asset delivery schedules can result in a mismatch of scheduled asset to the associated programming. For example, when a high value programming event such as a certain sporting event runs over the expected program length, it may sometimes occur that assets intended for another program or valued for a smaller audience may be shown when a higher value or better-tailored asset could have been used if a more dynamic scheduling regime were available. The asset targeting system allows for such dynamic scheduling as will be discussed in more detail below. The asset targeting system can also accommodate evolving standards in the field of dynamic scheduling.

C. The Conventional Asset Delivery Paradigm

Conventional broadcast networks may include asset-supported and premium content channels/networks. As noted above, programming content generally comes at a substantial cost. That is, the programming providers expect to be compensated for the programming that they provide which has generally been developed or acquired at significant cost. That compensation may be generated by asset delivery revenues, by fees paid by users for premium channels, or some combination of the two. In some cases, funding may come from another source such as public funding.

In the case of asset-supported networks, the conventional paradigm involves time-slot buys. Specifically, asset providers generally identify a particular program or time-slot on a particular network where they desire their assets to be aired. The cost for the airing of the asset depends on a number of factors, but one primary factor is the size of the audience for the programming in connection with which the asset is aired. Thus, the standard pricing model is based on the cost per thousand viewers (CPM), though other factors such as demographics or audience composition are involved as discussed below. The size of the audience is generally determined based on ratings. The most common benchmark for establishing these ratings is the system of Nielsen Media Research Corporation (Nielsen). One technique used by Nielsen involves monitoring the viewing habits of a presumably statistically relevant sampling of the universe of users. Based on an analysis of the sample group, the Nielsen system can estimate what portion of the audience particular programs received and, from this, an estimated audience size for the program can be projected. Thus, the historical performance of the particular program, for example, as estimated by the Nielsen system, may be used to set asset delivery prices for future breaks associated with that program.

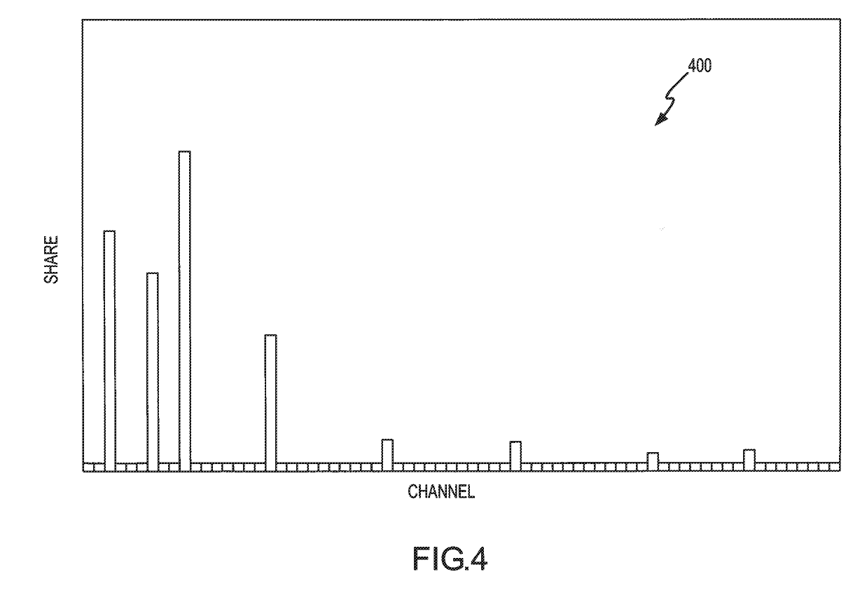

In practice, this results in a small number of programming networks being responsible for generating a large portion of the overall asset revenues. This general phenomenon is graphically depicted in FIG. 4, although the example is not based on actual numbers. As shown in FIG. 4, it is often the case that three or four programming networks out of many available programming networks garner very large shares whereas the remaining programming networks have small or negligible share. Indeed, in some cases, many programming networks will have a share that is so small that it is difficult to statistically characterize based on typical Nielsen sampling group sizes. In these cases, substantial asset revenues may be generated in connection with the small number of programming networks having a significant share while very little revenue is generated with respect to the other programming networks. This is true even though the other programming networks, in the aggregate, may have a significant number of users in absolute terms. Thus, the conventional paradigm often fails to generate revenues commensurate with the size of the total viewing audience serviced by the network operator. As discussed below, this is a missed revenue opportunity that can be addressed in accordance with the asset targeting system.

As noted above, the pricing for asset delivery depends on the size of the viewing audience and certain other factors. One of those factors relates to the demographics of interest to the asset provider. In this regard, a given program will generally have a number of different ratings for different demographic categories. That is, the program generally has not only a household rating, which is measured against the universe of all households with televisions, but also a rating for different demographic categories (e.g., males 18-24), measured against the universe of all members of the category who have televisions. Thus, the program may have a rating of 1 (1%) overall and a rating of 2 (2%) for a particular category. Typically, when asset providers buy a time-slot, pricing is based on a rating or ratings for the categories of interest to the asset provider. This results in significant inefficiencies due to poor matching of the audience to the desired demographics.

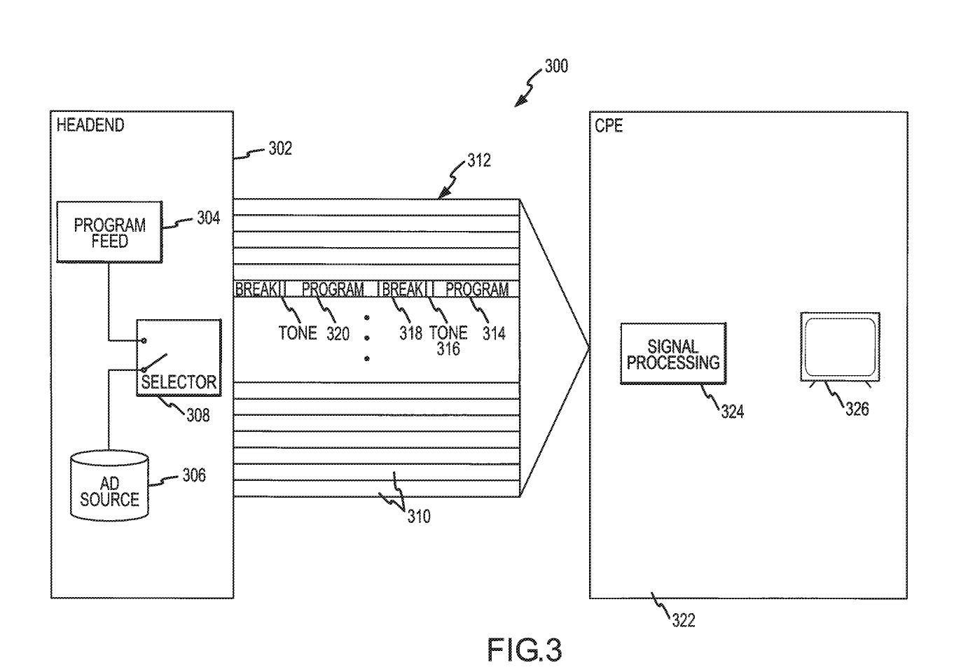

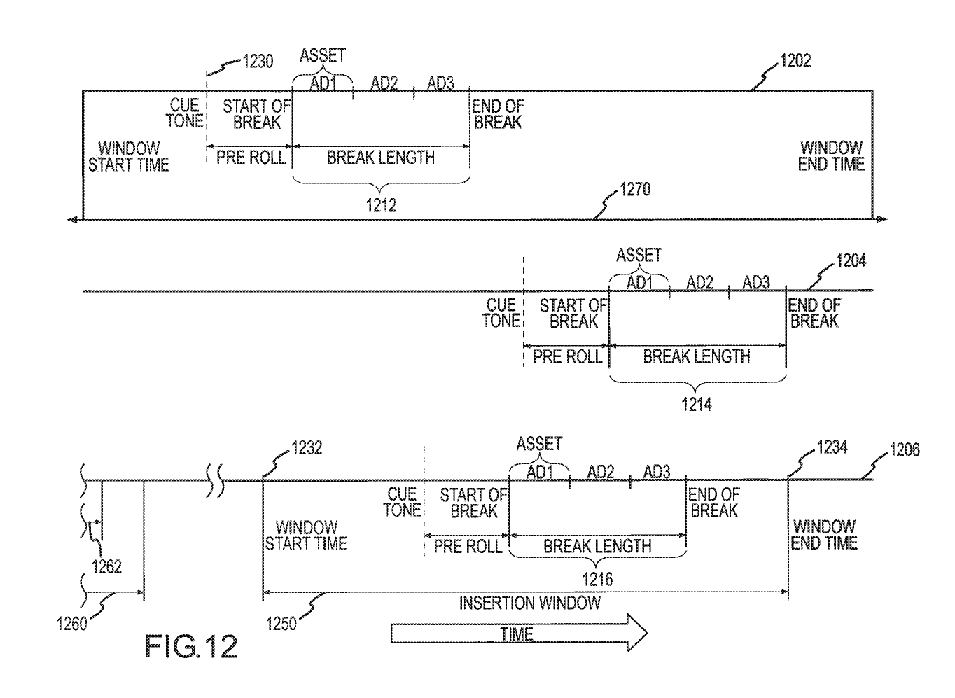

Conventionally, asset insertion is accomplished at the headend. This is illustrated in FIG. 3. In the illustrated system 300, the headend 302 includes a program feed 304 and an asset source 306. As noted above, the program feed 304 may be associated with a variety of programming sources such as video storage, an antenna, satellite dish or fiber feed from a studio or the like (FIG. 1). The asset source 306 may include a tape library or other storage system for storing pre-recorded assets. A platform associated with the headend 302—in this case, denoted a selector 308—inserts programming from the program feed 304 and assets from the asset source 306 into the video stream of an individual channel 310. This is done for each channel to define the overall content 312 that is distributed to subscribers (or at least to a node filter). Typically, although not necessarily, the selector 308 effectively toggles between the program feed 304 and the asset source 306 such that the programming and assets are inserted in alternating, non-time overlapping fashion. Thus, as shown in FIG. 3, a particular channel may include a time segment 314 of programming followed by a cue tone 316 (which may occur, for example, during a programming segment, or during a time period of an asset provided with the programming stream, just prior to an insertion opportunity) to identify the initiation of a break 318. In response to the tone, the selector 308 is operative to insert assets into the programming stream for that channel. At the conclusion of the break 318, the selector 308 returns to the program feed to insert a further programming segment 320. An example of a timeline in this regard is shown in FIG. 12 and discussed in detail below.

This content 312 or a filtered portion thereof is delivered to UEDs 322. In the illustrated embodiment the UED 322 is depicted as including a signal processing component 324 and a television display 326. It will be appreciated that these components 324 and 326 may be embodied in a single device and the nature of the functionality may vary. In the case of a digital cable user, the signal processing component 324 may be incorporated into a digital set top box (DSTB) for decoding digital signals. Such boxes are typically capable of bi-directional messaging with the headend 302 which will be a significant consideration in relation to functionality described below.

### II. System Overview

A. The Targeted Asset Delivery Environment

Against this backdrop described in the context of the conventional asset delivery paradigm, embodiments of the targeted asset delivery system are described below. These embodiments allow for delivery of targeted assets such as advertising so as to address certain shortcomings or inefficiencies of conventional broadcast networks. Generally, such targeting entails delivering assets to desired groups of individuals or individuals having desired characteristics. These characteristics or audience classification parameters may be defined based on personal information, demographic information, psychographic information, geographic information, or any other information that may be relevant to an asset provider in identifying a target audience. Preferably, such targeting is program independent in recognition that programming is a highly imperfect mechanism for targeting of assets. For example, even if user analysis indicates that a particular program has an audience comprised sixty percent of women, and women comprise the target audience for a particular asset, airing on that program will result in a forty percent mismatch. That is, forty percent of the users potentially reached may not be of interest to the asset provider and pricing may be based only on sixty percent of the total audience. Moreover, ideally, targeted asset delivery would allow for targeting with a range of granularities including very fine granularities. For example, it may be desired to target a group, such as based on a geographical grouping, a household characterization or even an individual user characterization. The present invention accommodates program independent targeting, targeting with a high degree of granularity and targeting based on a variety of different audience classifications.

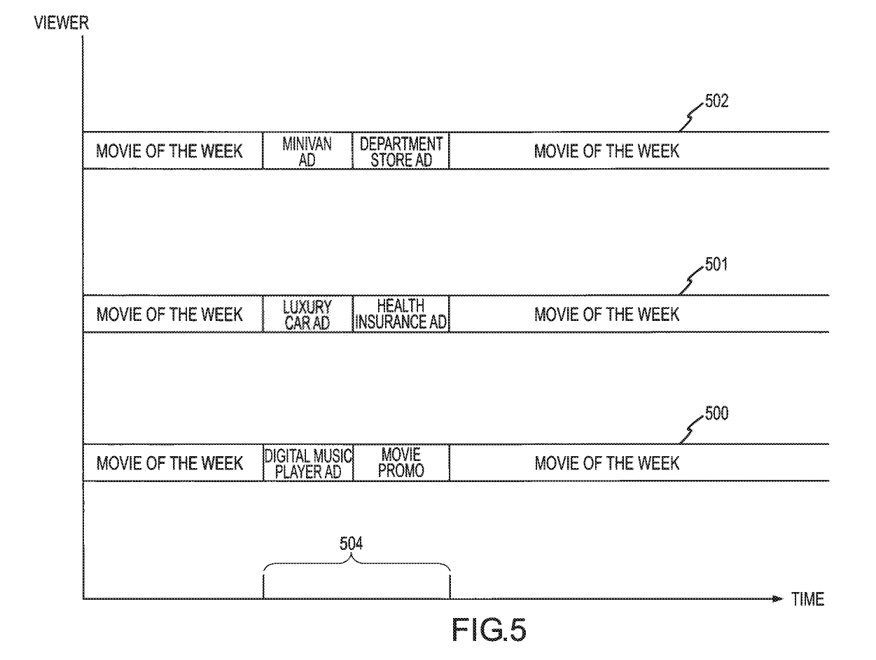

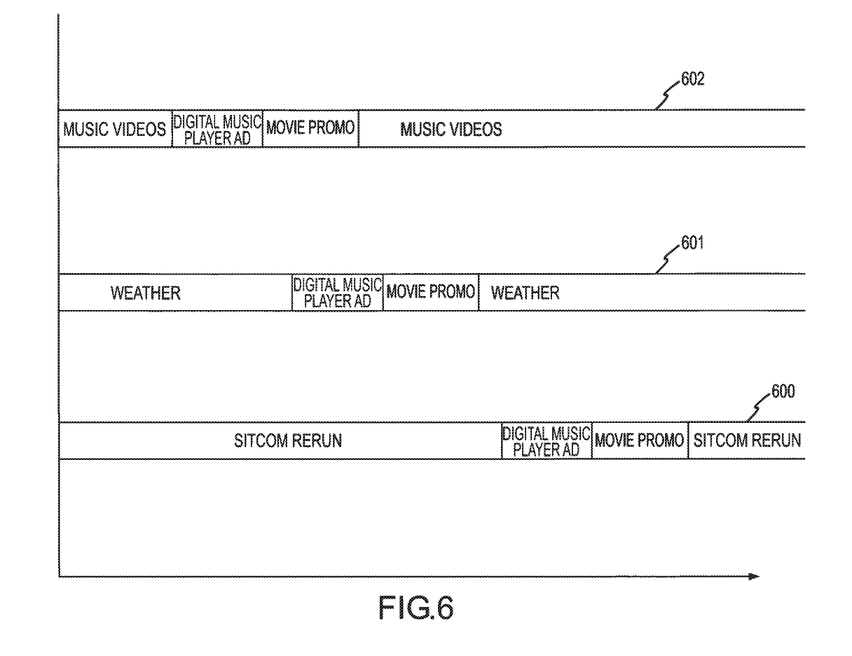

FIGS. 5 and 6 illustrate two different contexts of targeted asset delivery supported in accordance with the asset targeting system. Specifically, FIG. 5 illustrates the delivery of different assets, in this case ads, to different users watching the same programming channel, which may be referred to as spot optimization. As shown, three different users 500-502 are depicted as watching the same programming, in this case, denoted “Movie of the Week.” At a given break 504, the users 500-502 each receive a different asset package. Specifically, user 500 receives a digital music player ad and a movie promo, user 501 receives a luxury car ad and a health insurance ad, and user 502 receives a minivan ad and a department store ad. Alternately, a single asset provider (e.g., a motor vehicle company) may purchase a spot and then provide different asset options for the spot (e.g., sports car, minivans, pickup trucks, etc.). Similarly, separate advertisers may collectively purchase a spot and then provide ads for their respective products (e.g., where the target audiences of the advertisers are complementary). It will be appreciated that these different asset packages may be targeted to different audience demographics. In this manner, assets are better tailored to particular viewers of a given program who may fall into different demographic groups. Thus, spot optimization refers to the delivery of different assets (by one or multiple asset providers) in a given spot.

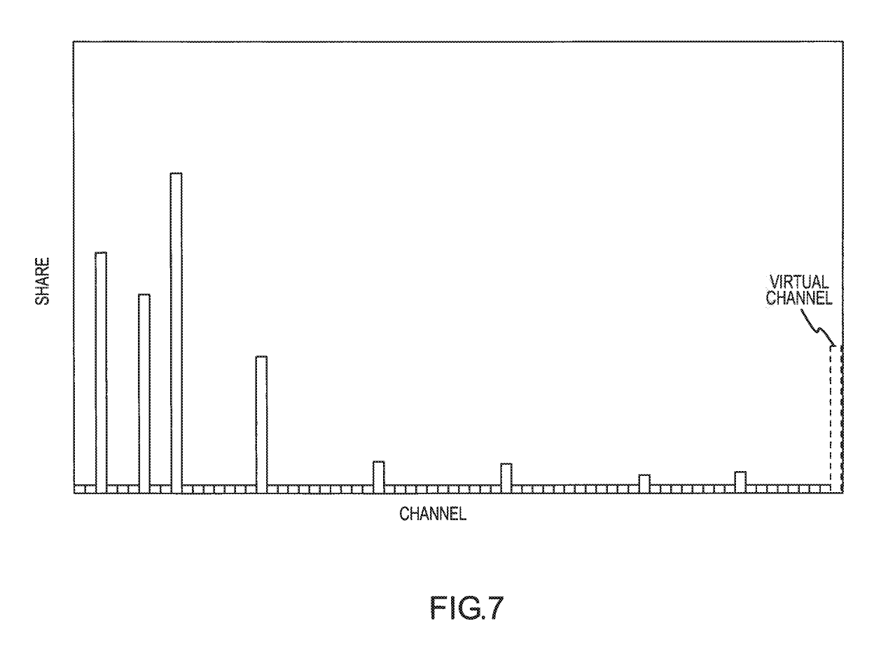

FIG. 6 illustrates a different context of the targeted asset delivery system, which may be termed audience aggregation. In this case, three different users 600-602 viewing different programs associated with different channels may receive the same asset or asset package. In this case, each of the users 600-602 receives a package including a digital music player ad and a movie promo in connection with breaks associated with their respective channels. Though the users 600-602 are shown as receiving the same asset package for purposes of illustration, it is likely that different users will receive different combinations of assets due to differences in classification parameters. In this manner, users over multiple channels (some or all users of each channel) can be aggregated (relative to a given asset and time window) to define a virtual channel having significant user numbers matching a targeted audience classification. Among other things, such audience aggregation allows for the possibility of aggregating users over a number of low share channels to define a significant asset delivery opportunity, perhaps on the order of that associated with one of the high share networks. This can be accomplished, in accordance with the present invention, using equipment already at a user's premises (i.e., an existing UED). Such a virtual channel is graphically illustrated in FIG. 7, though this illustration is not based on actual numbers. Thus, audience aggregation refers to the delivery of the same asset in different spots to define an aggregated audience. These different spots may occur within a time window corresponding to overlapping (conflicting) programs on different channels. In this manner, it is likely that these spots, even if at different times within the window, will not be received by the same users.

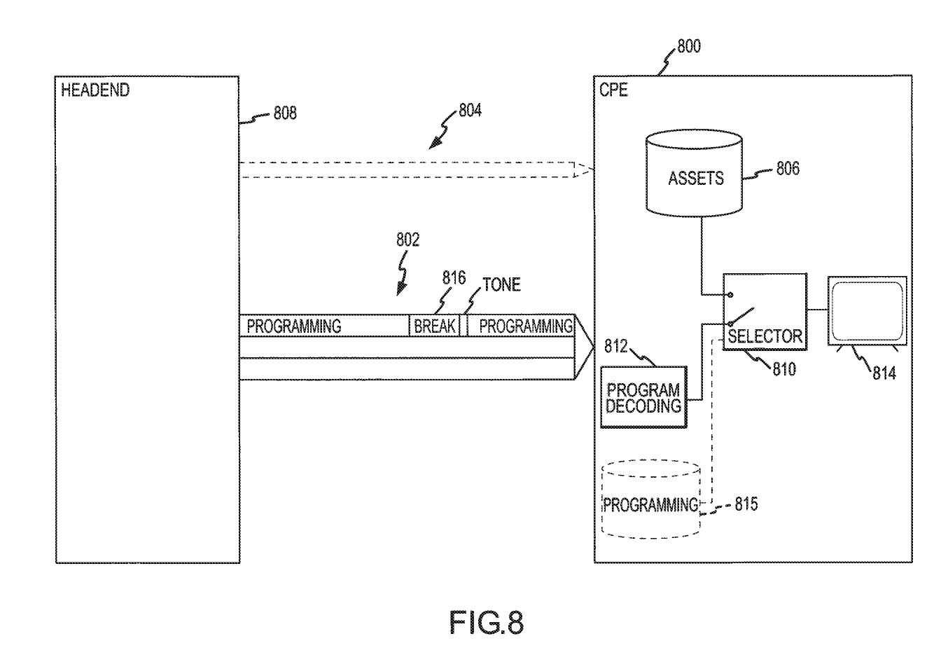

Such targeting including both spot optimization and audience aggregation can be implemented using a variety of architectures in accordance with the asset targeting system. Thus, for example, as illustrated in FIG. 8, targeted asset insertion can be implemented at the UEDs. This may involve a forward-and-store functionality. As illustrated in FIG. 8, the UED 800 receives a programming stream 802 and an asset delivery stream 804 from the headend 808. These streams 802 and 804 may be provided via a common signal link such as a coaxial cable or via separate communications links. For example, the asset delivery stream 804 may be transmitted to the UED 800 via a designated segment, e.g., a dedicated frequency range, of the available bandwidth or via a programming channel that is opportunistically available for asset delivery, e.g., when it is otherwise off air. The asset delivery stream 804 may be provided on a continuous or intermittent basis and may be provided concurrently with the programming stream 802. In the illustrated example, the programming stream 802 is processed by a program decoding unit, such as DSTB, and programming is displayed on television set 814. Alternatively, the programming stream 802 may be stored in programming storage 815 for UED insertion.

In the illustrated implementation, multiple assets available for insertion during a given break, or a flotilla of assets, together with metadata identifying, for example, any audience classification parameters of the targeted audience, is stored in a designated storage space 806 of the UED 800. It will be appreciated that substantial storage at the UED 800 may be required in this regard. For example, such storage may be available in connection with certain digital video recorder (DVR) units. A selector 810 is implemented as a processor running logic on the UED 800. The selector 810 functions analogously to the headend selector described above to identify breaks 816 and insert appropriate assets from the flotilla. In this case, the assets may be selected based on classification parameters of the household or, more preferably, a user within the household. Such classification parameters may be stored at the UED 800 or may be determined based on an analysis of viewing habits such as a click stream from a remote control as will be described in more detail below. Certain aspects of the present invention can be implemented in such a UED insertion environment.

Alternatively, rather than receiving and storing all of the assets in the flotilla, from which the UED 800 selects and inserts one or more appropriate assets, it may be assumed that the UED has received and stored the assets at some time in the past, and as a result, only a list describing the assets contained in the flotilla is sent to the UED 800 prior to an upcoming break. The selector 810 then inserts appropriate assets selected from the list. The fact that the assets themselves are not concurrently transmitted prior to the break leads to several benefits derived from the lack of any transmission bandwidth limitations. For instance, flotillas may be much larger (e.g., 20 asset options). It is also possible to achieve very specific targeting. That is, it is possible to target individual or very small groups of UEDs based on, for instance, household tags that identify classification information about a household or a user associated with a UED (e.g., brand of car owned, magazines subscribed to, income bracket, employment, etc.). This information is collected from third-party sources (e.g., Experian, Acxiom, Equifax) and stored in a third-party database on the headend 808 and may be used to match assets to households or users and to select appropriate assets for large or small groups of UEDs or even individual UEDs. In this regard, assets may be based on highly individualized household tags associated with each UED. For example, a household in which the father is a heart surgeon may receive an asset pertaining to a highly specialized defibrillator, while a household in which the mother is a patent attorney may receive an asset relating to patent searching services.

In a mixed system in which some of the UEDs 800 have storage capability (e.g., DVRs) while others are diskless, the system may implement two flotilla sizes. For instance, a first flotilla for the storage-capable UEDs may include a greater number of asset options (e.g., 12 asset options), while a second flotilla for the diskless UEDs may include a lesser number of asset options (e.g., 3 asset options).

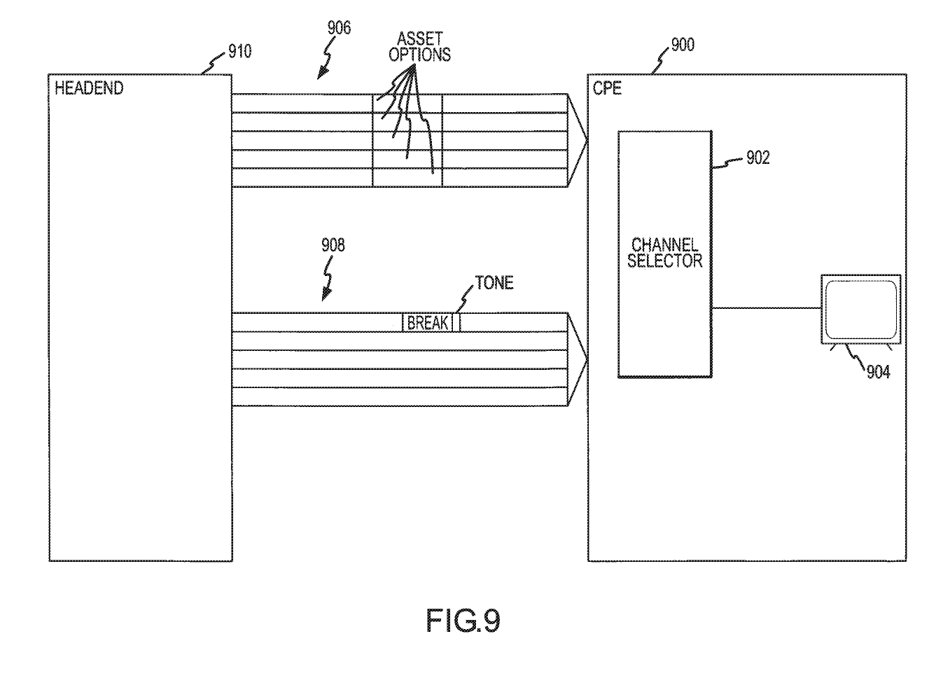

In FIG. 9, a different architecture is employed, which involves channel-hopping functionality. Specifically, in FIG. 9, asset options are transmitted from headend 910 synchronously with a given break on a given channel for which targeted asset options are supported. The UED 900 includes a channel selector 902 which is operative to switch to an asset channel associated with a desired asset at the beginning of a break and to return to the programming channel at the end of the break. The channel selector 902 may hop between channels (between asset channels or between an asset channel and the programming channel) during a break to select the most appropriate assets. In this regard, logic resident on the UED 900 controls such hopping to avoid switching to a channel where an asset is already in progress. As described below, this logic can be readily implemented, as the schedule of assets on each asset channel is known. Preferably, all of this is implemented invisibly from the perspective of the user of set 904. The different options may be provided, at least in part, in connection with asset channels 906 or other bandwidth segments (separate from programming channels 908) dedicated for use in providing such options. In addition, certain asset options may be inserted into the current programming channel 908. Associated functionality is described in detail below. The architecture of FIG. 9 has the advantage of not requiring substantial storage resources at the UED 900 such that it can be immediately implemented on a wide scale basis using equipment that is already in the field.

As a further alternative, the determination of which asset to show may be made remotely at the headend or at another remote platform. For example, an asset may be selected based on UED voting as described below, and inserted at the headend into the programming channel without options on other asset channels. This would achieve a degree of targeting but without spot optimization opportunities as described above. Still further, options may be provided on other asset channels, but the selection as between those channels may be determined by the headend based on, for example, household tags, as discussed above. Further, to account for a variety of audiences associated with any given UED (e.g., a mother, a father, teenage sons), user inputs, such as real-time inputs transmitted to a given UED (typically channel selections, volume settings, and the like transmitted through an RF device such as a remote control), may be transmitted upstream to the headend or other remote platform and used to continually estimate classification parameters associated with “who's watching now” (e.g., age, gender, ethnicity), as described in U.S. application Ser. No. 12/239,475, entitled “Targeted Advertising in Unicast, Multicast and Hybrid Distribution System Contexts,” the contents of which are incorporated herein by reference (the “Remote Delivery Application”). These additional classification parameters may be used to further refine the asset selected for the UED based upon knowledge of the current viewership.

Once the remote determination is made regarding which asset to show, the asset may be inserted into separate streams for the programming content and the selected asset or into a single content stream that also contains the programming content, respectively. For instance, the UED may be instructed that it is associated with an “ACME preferred” customer. When an asset is disseminated with ACME preferred metadata, the UED may be caused to select that asset channel, thereby overriding (or significantly factoring with) any other audience classification considerations. Alternatively, the asset may be inserted into a customized content stream containing the programming content and unicast directly to the UED or multicast to a selected group of UEDs to receive the same asset, as described in the Remote Delivery Application. Remote asset determination and delivery reduces the bi-directional messaging traffic required for voting as well as the need for voting logic and substantial asset storage at each UED. As a result, remote asset determination and delivery requires less network bandwidth and facilitates targeted asset delivery to existing equipment at the user's premises.

A significant opportunity thus exists to better target users whom asset providers may be willing to pay to reach and to better reach hard-to-reach users. However, a number of challenges remain with respect to achieving these objectives including: how to obtain sufficient information for effective targeting while addressing privacy concerns; how to address a variety of business related issues, such as pricing of asset delivery, resulting from availability of asset options and attendant contingent delivery; and how to operate effectively within the context of existing network structure and systems (e.g., across node filters, using existing traffic and billing systems, etc.).

From the foregoing it will be appreciated that various aspects of the invention are applicable in the context of a variety of networks, including broadcast networks. In the following discussion, specific implementations of a targeted asset system are discussed in the context of a cable television network. Though the system enhances viewing for both analog and digital users, certain functionality is conveniently implemented using existing DSTBs. It will be appreciated that, while these represent particularly advantageous and commercially valuable implementations, the invention is not limited to these specific implementations or network contexts.

B. System Architecture

In one implementation, the system of the present invention involves the transmission of asset options in time alignment or synchronization with other assets on a programming channel, where the asset options are at least partially provided via separate bandwidth segments, e.g. channels at least temporarily dedicated to targeted asset delivery. Although such options may typically be transmitted in alignment with a break in programming, it may be desired to provide options opposite continuing programming (e.g., so that only subscribers in a specified geographic area get a weather announcement, an emergency announcement, election results or other local information while others get uninterrupted programming). Selection as between the available options may be implemented at the user's premises, as by a DSTB in this implementation. In this manner, asset options are made available for better targeting, without the requirement for substantial storage resources or equipment upgrades at the user's premises (e.g., as might be required for a forward-and-store architecture). Indeed, existing DSTBs can be configured to execute logic for implementing the system described below by downloading and/or preloading appropriate logic.

Because asset options are synchronously transmitted in this implementation, it is desirable to be efficient in identifying available bandwidth and in using that bandwidth. In this regard, various functionality exists for improving bandwidth identification, e.g., identifying bandwidth that is opportunistically available in relation to a node filter. Efficient use of available bandwidth involves both optimizing the duty cycle or asset density of an available bandwidth segment (i.e., how much time, of the time a bandwidth segment is available for use in transmitting asset options, is the segment actually used for transmitting options) and the value of the options transmitted. The former factor is addressed, among other things, by improved scheduling of targeted asset delivery on the asset channels in relation to scheduled breaks of the programming channels.

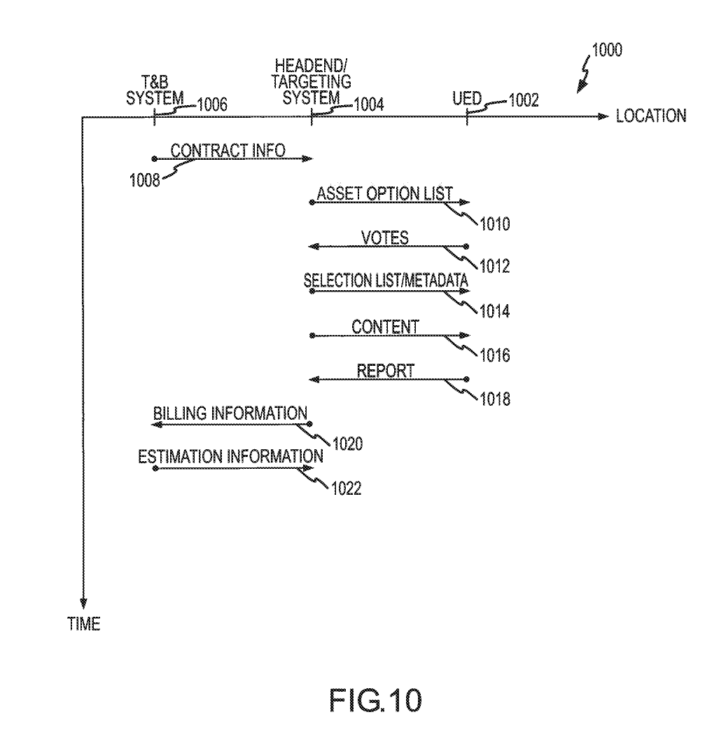

The latter factor is addressed in part by populating the available bandwidth spots with assets that are most desired based on current network conditions. As discussed above, these most desired assets can be determined in a variety of ways including based on conventional ratings. In the specific implementation described below, the most desired assets are determined via a process herein termed voting. FIG. 10 illustrates an associated messaging sequence 1000 in this regard as between a UED 1002 such as a DSTB, a network platform for asset insertion such as a headend 1004 and a traffic and billing (T&B) system 1006 used in the illustrated example for obtaining asset delivery orders or contracts and billing for asset delivery. It will be appreciated that the functionality of the T&B system 1006 may be split between multiple systems running on multiple platforms and the T&B system 1006 may be operated by the network operator or may be separately operated.

The illustrated sequence begins by loading contract information 1008 from the T&B system 1006 onto the headend 1004. An interface associated with system 1006 allows asset providers to execute contracts for dissemination of assets based on traditional time-slot buys (for a given program or given time on a given network) or based on a certain audience classification information (e.g., desired demographics, psychographics, geography, and/or audience size). In the latter case, the asset provider or network may identify audience classification information associated with a target audience. The system 1006 uses this information to compile the contract information 1008 which identifies the asset that is to be delivered together with delivery parameters regarding when and to whom the asset is to be delivered.

The illustrated headend 1004 uses the contract information together with a schedule of breaks for individual networks to compile an asset option list 1010 on a channel-by-channel and break-by-break basis. That is, the list 1010 lists the universe of asset options that are available for voting purposes for a given break on a given programming channel together with associated metadata identifying the target audience for the asset, e.g., based on audience classification information. The transmitted list 1010 may encompass all supported programming channels and may be transmitted to all participating users, or the list may be limited to one or a subset of the supported channels, e.g., based on an input indicating the current channel or the most likely or frequent channels used by a particular user or group of users. The list 1010 is transmitted from the headend 1004 to the UED 1002 in advance of a break for which options are listed.

Based on the list 1010, the UED 1002 submits a vote 1012 back to the headend 1004. More specifically, the UED 1002 first identifies the classification parameters for the current user(s) and perhaps the current channel being watched, identifies the assets that are available for an upcoming break (for the current channel or multiple channels) as well as the target audience for those assets and determines a “fit” of one or more of those asset options to the current classification. In one implementation, each of the assets is attributed a fit score for the user(s), e.g., based on a comparison of the audience classification parameters of the asset to the putative audience classification parameters of the current user(s). This may involve how well an individual user classification parameter matches a corresponding target audience parameter and/or how many of the target audience parameters are matched by the user's classification parameters. Based on these fit scores, the UED 1002 issues the vote 1012 indicating the most appropriate asset(s). Any suitable information can be used to provide this indication. For example, all scores for all available asset options (for the current channel or multiple channels) may be included in the vote 1012. Alternatively, the vote 1012 may identify a subset of one or more options selected or deselected by the UED 1002, with or without scoring information indicating a degree of the match and may further include channel information. In one implementation, the headend 1004 instructs UEDs (1002) to return fit scores for the top N asset options for a given spot, where N is dynamically configurable based on any relevant factor such as network traffic levels and size of the audience. Preferably, this voting occurs shortly before the break at issue such that the voting more accurately reflects the current status of network users. In one implementation, votes are only submitted for the programming channel to which the UED is set, and votes are submitted periodically, e.g., every fifteen minutes.

The headend 1004 compiles votes 1012 from UEDs 1002 to determine a set of selected asset options 1014 for a given break on a supported programming channel. As will be understood from the description below, such votes 1012 may be obtained from all relevant and participating UEDs 1002 (who may be representative of a larger audience including analog or otherwise non-participating users) or a statistical sampling thereof. In addition, the headend 1004 determines the amount of bandwidth (e.g., the number of dedicated asset option channels) that are available for transmission of options in support of a given break for a given programming channel.

Based on all of this information, the headend 1004 assembles a flotilla of assets, e.g., the asset options having the highest vote values or the highest weighted vote values where such weighting takes into account value per user or other information beyond classification fit. Such a flotilla may include asset options inserted on the current programming channel as well as on asset channels, though different insertion processes and components may be involved for programming channel and asset channel insertion. It will be appreciated that some flotillas may be assembled independently or largely independently of voting, for example, certain public service spots or where a certain provider has paid a premium for guaranteed delivery. Also, in spot optimization contexts where a single asset provider buys a spot and then provides multiple asset options for that spot, voting may be unnecessary (though voting may still be used to select the options). Further, in situations in which a flotilla is constructed based on household tags, as discussed above, audience estimates may be made without voting since a complete database of household tags is maintained at the headend. Alternatively, the nature of the votes may be altered from an indication of an asset preference or match to an indication of a channel selection, whether the UED is on, whether a user is present at the UED, a probability associated with a user being present at the UED (e.g., there is 30% probability that a user is present at the UED), or any combination of these options.

In one implementation, the flotilla is assembled into sets of asset options for each dedicated asset channel, where the time length of each set matches the length of the break, such that channel hopping within a break is unnecessary. Alternatively, the UED 1002 may navigate between the asset channels to access desired assets within a break (provided that asset starts on the relevant asset channels are synchronized). However, it will be appreciated that the flotilla matrix (where columns include options for a given spot and rows correspond to channels) need not be rectangular. Stated differently, some channels may be used to provide asset options for only a portion of the break, i.e., may be used at the start of the break for one or more spots but are not available for the entire break, or may only be used after one or more spots of a break have aired. A list of the selected assets 1014 and the associated asset channels is then transmitted together with metadata identifying the target audience in the illustrated implementation. It will be appreciated that it may be unnecessary to include the metadata at this step if the UED 1002 has retained the asset option list 1010. This list 1014 is preferably transmitted shortly in advance of transmission of the asset 1016 (which includes sets of asset options for each dedicated contact options channel used to support, at least in part, the break at issue).

The UED 1002 receives the list of selected asset options 1014 and associated metadata and selects which of the available options to deliver to the user(s). For example, this may involve a comparison of the current audience classification parameter values (which may or may not be the same as those used for purposes of voting) to the metadata associated with each of the asset options. The selected asset option is used to selectively switch the UED 1002 to the corresponding dedicated asset options channel to display the selected asset 1016 at the beginning of the break at issue. One of the asset option sets, for example, the one comprised of the asset receiving the highest vote values, may be inserted into the programming channel so that switching is not required for many users. Assuming that the voting UEDs are at least somewhat representative of the universe of all users, a significant degree of targeting is thereby achieved even for analog or otherwise non-participating users. In this regard, the voters serve as proxies for non-voting users. The UED 1002 returns to the programming channel at the conclusion of the break. Preferably, all of this is automatic from the perspective of the user(s), i.e., preferably no user input is required. The system may be designed so that any user input overrides the targeting system. For example, if the user changes channels during a break, the change will be implemented as if the targeting system was not in effect (e.g., a command to advance to the next channel will set the UED to the channel immediately above the current programming channel, without regard to any options currently available for that channel, regardless of the dedicated asset channel that is currently sourcing the television output).

In this system architecture, as in forward-and-store architectures or any other option where selections between asset options are implemented at the UED, there will be some uncertainty as to how many users or households received any particular asset option in the absence of reporting. This may be tolerable from a business perspective. In the absence of reporting, the audience size may be estimated based on voting data, conventional ratings analysis and other tools. Indeed, in the conventional asset delivery paradigm, asset providers accept Nielsen rating estimates and demographic information together with market analysis to gauge return on investment. However, this uncertainty is less than optimal in any asset delivery environment and may be particularly problematic in the context of audience aggregation across multiple programming networks, potentially including programming networks that are difficult to measure by conventional means.

The system of the present invention preferably implements a reporting system by which individual UEDs 1002 report back to the headend 1004 what asset or assets were delivered at the UED 1002 and, optionally, to whom (in terms of audience classification). Additionally, the reports may indicate where (on what programming channel) the asset was delivered and how much (if any) of the asset was consumed. Such reports 1018 may be provided by all participating UEDs 1002 or by a statistical sampling thereof. These reports 1018 may be generated on a break-by-break basis, periodically (e.g., every 15 minutes) or may be aggregated prior to transmission to the headend 1004. Reports may be transmitted soon after delivery of the assets at issue or may be accumulated, e.g., for transmission at a time of day where messaging bandwidth is more available. Moreover, such reporting may be coordinated as between the UEDs 1002 so as to spread the messaging load due to reporting.

In any case, the reports 1018 can be used to provide billing information 1020 to the T&B system 1006 for valuing the delivery of the various asset options. For example, the billing information 1020 can be used by the T&B system 1006 to determine how large an audience received each option and how well that audience matched the target audience. For example, as noted above, a fit score may be generated for particular asset options based on a comparison of the audience classification to the target audience. This score may be on any scale, e.g., 1-100. Goodness of fit may be determined based on this raw score or based on characterization of this score such as “excellent”, “good”, etc. Again, this may depend on how well an individual audience classification parameter of a user matches a corresponding target audience parameter and/or how many of the target audience parameters are matched by the user's audience classification parameters. This information may in turn be provided to the asset provider, at least in an aggregated form. In this manner, the network operator can bill based on guaranteed delivery of targeted messages or scale the billing rate (or increase delivery) based on goodness of fit as well as audience size. The reports (and/or votes) 1018 can also provide a quick and detailed measurement of user distribution over the network that can be used to accurately gauge ratings share, demographics of audiences and the like. Moreover, this information can be used to provide future audience estimation information 1022, for example, to estimate the total target universe based on audience classification parameters.

It will thus be appreciated that the present invention allows a network operator such as an MSO to sell asset delivery under the conventional asset delivery (time-slot) buy paradigm or under the new commercial impression paradigm or both. For example, a particular MSO may choose to sell asset delivery space for the major networks (or for these networks during prime time) under the old time-slot buy paradigm while using the commercial impression paradigm to aggregate users over multiple low market share networks. Another MSO may choose to retain the basic time-slot buy paradigm while accommodating asset providers who may wish to fill a given slot with multiple options targeted to different demographics. Another MSO may choose to retain the basic time-slot buy paradigm during prime time across all networks while using the targeted impression paradigm to aggregate users at other times of the day. The targeted impression paradigm may be used by such MSOs only for this limited purpose.

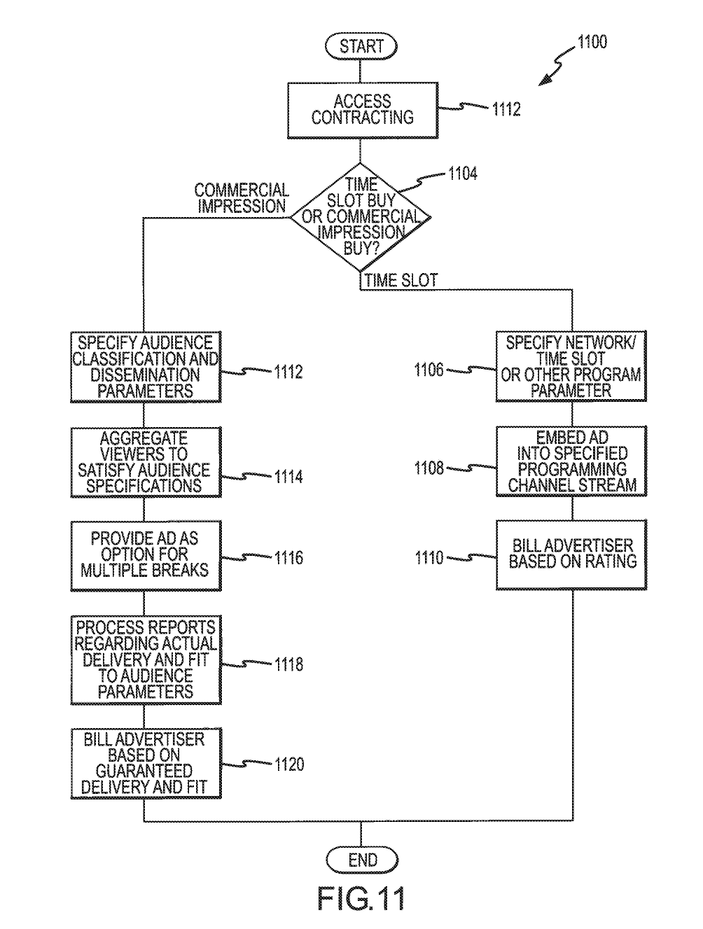

FIG. 11 is a flow chart illustrating an associated process 1100. An asset provider (or agent thereof) can initiate the illustrated process 1100 by accessing (1102) a contracting platform as will be described below. Alternatively, an asset provider can work with the sales department or other personnel of a system operator or other party who accesses such a platform. As a still further alternative, an automated buying system may be employed to interface with such a platform via a system-to-system interface. This platform may provide a graphical user interface by which an asset provider can design a dissemination strategy (e.g., an ad campaign) and enter into a corresponding contract for dissemination of an asset. The asset provider can then use the interface to select (1104) to execute either a time-slot buy strategy or a targeted impression buy strategy. In the case of a time-slot buy strategy, the asset provider can then use the user interface to specify (1106) a network and time-slot or other program parameter identifying the desired air times and frequency for delivery of the asset. Thus, for example, an asset provider may elect to air the asset in connection with specifically identified programs believed to have an appropriate audience. In addition, the asset provider may specify that the asset is to appear during the first break or during multiple breaks during the program. The asset provider may further specify that the asset is to be, for example, aired during the first spot within the break, the last spot within the break or otherwise designate the specific asset delivery slot.

Once the time-slots for the asset have thus been specified, the MSO causes the asset to be embedded (1108) into the specified programming channel asset stream. The asset is then available to be consumed by all users of the programming channel. The MSO then bills (1110) the asset provider, typically based on associated ratings information. For example, the billing rate may be established in advance based on previous rating information for the program in question, or the best available ratings information for the particular airing of the program may be used to bill the asset provider. It will thus be appreciated that the conventional time-slot buy paradigm is limited to delivery to all users for a particular time-slot on a particular network and does not allow for targeting of particular users of a given network or targeting users distributed over multiple networks in a single buy.

In the case of targeted impression buys, the asset provider can use the user interface as described in more detail below to specify (1112) audience classification and other dissemination parameters. In the case of audience classification parameters, the asset provider may specify the gender, age range, income range, geographical location, lifestyle interest or other information of a targeted audience. The additional dissemination parameters may relate to delivery time, frequency, audience size, or any other information useful to define a target audience. Combinations of parameters may also be specified. For example, an asset provider may specify an audience size of 100,000 in a particular demographic group and further specify that the asset is not delivered to any user who has already received the asset a predetermined number of times.

Based on this information, the targeted asset system of the present invention is operative to target appropriate users. For example, this may involve targeting only selected users of a major network. Additionally or alternatively, this may involve aggregating (1114) users across multiple networks to satisfy the audience specifications. For example, selected users from multiple programming channels may receive the asset within a designated time period in order to provide an audience of the desired size, where the audience is composed of users matching the desired audience classification. The user interface preferably estimates the target universe based on the audience classification and dissemination parameters such that the asset provider receives an indication of the likely audience size.

The aggregation system may also be used to do time of day buys. For example, an asset provider could specify audience classification parameters for a target audience and further specify a time and channel for airing of the asset. UEDs tuned to that channel can then select the asset based on the voting process as described herein. Also, asset providers may designate audience classification parameters and a run time or time range, but not the programming channel. In this manner, significant flexibility is enabled for designing a dissemination strategy. It is also possible for a network operator to disable some of these strategy options, e.g., for business reasons.

Based on this input information, the targeted asset system of the present invention is operative to provide the asset as an option during one or more time-slots of one or more breaks. In the case of spot optimization, multiple asset options may be disseminated together with information identifying the target audience so that the most appropriate asset can be delivered at individual UEDs. In the case of audience aggregation, the asset may be provided as an option in connection with multiple breaks on multiple programming channels. The system then receives and processes (1118) reports regarding actual delivery of the asset by UEDs and information indicating how well the actual audience fit the classification parameters of the target audience. The asset provider can then be billed (1120) based on guaranteed delivery and goodness of fit based on actual report information. It will thus be appreciated that a new asset delivery paradigm is defined by which assets are targeted to specific users rather than being associated with particular programs. This enables both better targeting of individual users for a given program and improved reach to target users on low-share networks.

From the foregoing, it will be appreciated that various steps in the messaging sequence are directed to matching assets to users based on classification parameters, allowing for goodness of fit determinations based on such matching or otherwise depending on communicating audience classification information across the network. It is preferable to implement such messaging in a manner that is respectful of user privacy concerns and relevant regulatory regimes.

Much of the discussion above has referenced audience classification parameters as relating to individuals as opposed to households. Methods for identifying audience classification parameters are set forth in U.S. application Ser. No. 11/332,771, entitled, “VOTING AND HEADEND INSERTION,” the contents of which are incorporated herein by reference. In a first implementation, logic associated with the UED uses probabilistic modeling, fuzzy logic and/or machine learning to progressively estimate the audience classification parameter values of a current user or users based on the click stream. This process may optionally be supplemental based on stored information (preferably free of sensitive information) concerning the household that may, for example, affect probabilities associated with particular inputs. In this manner, each user input event (which involves one or more items of change of status and/or duration information) can be used to update a current estimate of the audience classification parameters based on associated probability values. The fuzzy logic may involve fuzzy data sets and probabilistic algorithms that accommodate estimations based on inputs of varying and limited predictive value.

In a second implementation, the click stream is modeled as an incomplete or noisy signal that can be processed to obtain audience classification parameter information. More specifically, a series of clicks over time or associated information can be viewed as a time-based signal. This input signal is assumed to reflect a desired signature or pattern that can be correlated to audience classification parameters. However, the signal is assumed to be incomplete or noisy—a common problem in signal processing. Accordingly, filtering techniques are employed to estimate the “true” signal from the input stream and associated algorithms correlate that signal to the desired audience classification information. For example, a nonlinear adaptive filter may be used in this regard.

One of the audience classifications that may be used for targeting is location. Specifically, an asset provider may wish to target only users within a defined geographic zone (e.g., proximate to a business outlet) or may wish to target different assets to different geographic zones (e.g., targeting different car ads to users having different supposed income levels based on location). In certain implementations, the present invention determines the location of a particular UED and uses the location information to target assets to the particular UED. It will be appreciated that an indication of the location of a UED contains information that may be considered sensitive. The present invention also creates, extracts and/or receives the location information in a manner that addresses these privacy concerns. This may also be accomplished by generalizing or otherwise filtering out sensitive information from the location information sent across the network. This may be accomplished by providing filtering or sorting features at the UED or at the headend. For example, information that may be useful in the reporting process (i.e. to determine the number of successful deliveries within a specified location zone) may be sent upstream with little or no sensitive information included. Additionally, such location information can be generalized so as to not be personally identifiable. For example, all users on a given block or within another geographic zone (such as associated with a zip plus 2 area) may be associated with the same location identifier (e.g., a centroid for the zone).

Similarly, it is often desired to associate tags with asset selections. Such tags are additional information that is superimposed on or appended to such assets. For example, a tag may provide information regarding a local store or other business location at the conclusion of an asset that is distributed on a broader basis. Conventionally, such tags have been appended to assets prior to insertion at the headend and have been limited to coarse targeting. In accordance with the present invention, tags may be targeted to users in particular zones, locations or areas, such as neighborhoods. Tags may also be targeted based on other audience classification parameters such as age, gender, income level, etc. For example, tags at the end of a department store ad may advertise specials on particular items of interest to particular demographics. Specifically, a tag may be included in an asset flotilla and conditionally inserted based on logic contained within the UED 1101. Thus the tags are separate units that can be targeted like other assets, however, with conditional logic such that they are associated with the corresponding asset.

Targeting may also be implemented based on marketing labels. Specifically, the headend may acquire information or marketing labels regarding a user or household from a variety of sources. These marketing labels may indicate that a user buys expensive cars, is a male 18-24 years old, or other information of potential interest to an asset provider. In some cases, this information may be similar to the audience classification parameters, though it may optionally be static (not varying as television users change) and based on hard data (as opposed to being surmised based on viewing patterns or the like). In other cases, the marketing labels may be more specific or otherwise different than the audience classification. In any event, the headend may inform the UED as to what kind of user/household it is in terms of marketing labels. An asset provider can then target an asset based on the marketing labels and the asset will be delivered by UEDs where targeting matches. This can be used in audience aggregation and spot optimization contexts.

Thus, the targeted asset system of the present invention allows for targeting of assets in a broadcast network based on any relevant audience classification, whether determined based on user inputs such as a click stream, based on marketing labels or other information pushed to the customer premises equipment, based on demographic or other information stored or processed at the headend, or based on combinations of the above or other information. In this regard, it is therefore possible to use, in the context of a broadcast network, targeting concepts that have previously been limited to other contexts such as direct mail. For example, such targeting may make use of financial information, previous purchase information, periodical subscription information and the like. Moreover, classification systems developed in other contexts may be leveraged to enhance the value of targeting achieved.

An overview of an exemplary system has thus been provided, including introductory discussions of major components of the system, which provides a system context for understanding the operation of those components.

### III. Component Overview

A. Measurement and Voting

Generally, signals received from a UED 1002 are utilized by the present systems and methods for at least three separate applications, which in some instances may also be combined. See FIG. 10. These applications may be termed measurement, voting and reporting, as described in U.S. Pat. No. 7,546,619, entitled “VOTING AND HEADEND INSERTION MODEL FOR TARGETING CONTENT IN A BROADCAST NETWORK,” the contents of which are incorporated herein by reference. Reporting is described in more detail below. Measurement relates to the use of the signals to identify the audience size and, optionally, the classification composition of the audience. This information assists in estimating the universe of users available for targeting, including an estimate of the size and composition of an audience that may be aggregated over multiple channels (e.g., including low share channels) to form a substantial virtual channel. Accordingly, a targeted asset may be provided for the virtual channel to enhance the number of users who receive the asset. Voting involves the use of signals received from UEDs 1012 to provide an asset based on asset performance indications from the UEDs. In any case, assets may be selected and inserted into one or more transmitted data streams based on signals received from one or more UEDs.

With regard to audience measurement, the two-way communication between the headend and UED allows for gathering information which may indicate, at least implicitly, information regarding audience size and audience classification composition. In this regard, individual UEDs may periodically or upon request provide a signal to the headend indicating, for example, that an individual UED is active and what channel is currently being displayed by the UED. This information, which may be provided in connection with voting, reporting on other messages (e.g., messages dedicated to measurement) can be used to infer audience size and composition. Wholly apart from the targeted asset system, such information may be useful to support ratings and share information or for any other audience measurement objective. Referring briefly to FIG. 7, it is noted that of the available programming channels, four programming channels have the largest individual share of users (e.g., the four major networks). However, there are numerous other users in the network albeit in smaller shares of the total on a channel-by-channel basis. By providing a common set of asset options to the users of two or more of the programming channels having a small market share (or even to users of programming channels with large shares), a virtual channel may be created. That is, a common asset option or set of asset options may be provided to an aggregated group from multiple programming channels. Once combined, the effective market share of a virtual channel composed of users from small share channels may approximate the market share of, for example, one of the four major networks.

While the aggregation of the users of multiple programming channels into a virtual channel allows for providing a common set of asset options to each of the programming channels, it will be appreciated that the asset will generally be provided for each individual programming channel at different times. This is shown in FIG. 12 where two different programming channels (e.g., 1202 and 1204), which may be combined into a virtual channel, have different scheduled breaks 1212, 1214. In this regard, an asset may be provided on the first channel 1202 prior to when the same asset is provided on the second channel 1204. However, this common asset may still be provided within a predetermined time window (e.g., between 7 p.m. and 8 p.m.). In this regard, the asset may be delivered to the aggregated market share represented by the virtual channel (or a subset thereof) within defined constraints regarding delivery time. Alternatively, the size of such an aggregated audience may be estimated in advance based on previous reporting, ratings and census data, or any other technique. Thus measurement or voting is not necessary to accomplish targeting, though such detailed asset information is useful. Actual delivery may be verified by subsequent reporting. As will be appreciated, such aggregation allows a network operator to disseminate assets based on the increased market share of the virtual channel(s) in relation to any one of the subsumed programming channels, as well as allowing an asset provider to more effectively target a current viewing audience.

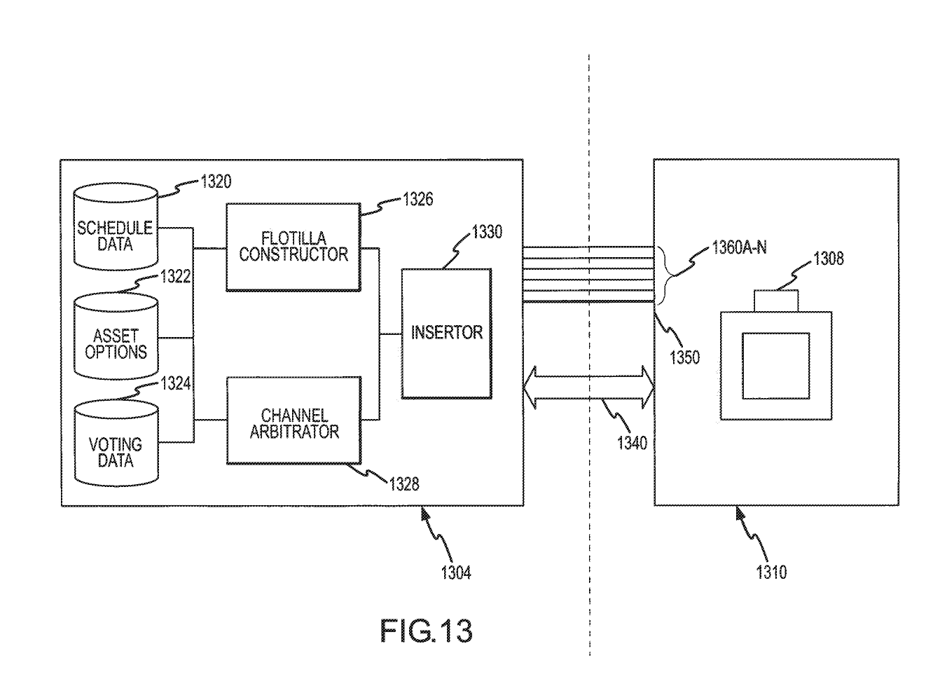

Another application that is supported by signals from UEDs is the provision of targeted assets to current users of one or more channels within the network, e.g., based on voting. Such an application is illustrated in FIG. 13, where, in one arrangement, signals received from UEDs 1310 (only one shown) may be utilized to select assets (e.g., a break asset and/or programming) for at least one programming channel 1350. In this regard, such assets may be dynamically selected for insertion into the data stream of the programming channel 1350, for example, during a break or other designated time period. In a further arrangement, unused bandwidth of the network is utilized to provide parallel asset streams during a break or designated time period of the targeted channel 1350. In the context of a break, multiple asset channels 1360A-N may be used to provide asset options during a single break, wherein each asset channel 1360A-N may provide options directed to different groups of viewers and/or otherwise carry different assets (e.g., users having similar audience classification parameters may receive different assets due to a desired sequencing of packaged assets as discussed below).

In such an arrangement, the UED 1310 may be operative to select between alternate asset channels 1360A-N based on the signals from the UED 1360. In addition to targeted audience aggregation, such a system may be desirable to enhance revenues or impact for programming, including large share programming (spot optimization). That is, a single break may be apportioned to two or more different asset providers, or, a single asset provider may provide alternate assets where the alternate assets target different groups of users. Though discussed herein as being directed to providing different break or interstitial assets to different groups of users, it should be noted that the system may also be utilized to provide different programming assets.

An associated asset targeting system implementing a voting process is also illustrated in FIG. 13. The asset targeting system of FIG. 13 has a platform 1304, which includes a structure of the network (i.e., upstream from the users/households) that is operative to communicate with UEDs 1310 (only one shown) within the network. The illustrated UED 1310 includes a signal processing device 1308, which in the present illustration is embodied in a DSTB. Generally, the platform 1304 is operative to communicate with the UED 1310 via a network interface 1440. In order to provide parallel asset channels 1360A-N during a break of a programming channel, e.g., channel 1350, the platform 1304 is in communication with one or more of the following components: a schedule database 1320, an available asset option database 1322, voting database 1324, a flotilla constructor 1326, a channel arbitrator 1328, and an inserter 1330. Of note, the listed components 1320-1330 do not have to be located at a common network location. That is, the various components of the platform 1304 may be distributed over separate locations within the network and may be interconnected by any appropriate communication interfaces.

Generally, the schedule database 1320 includes information regarding the timing of breaks for one or more programming channels, the asset option database 1322 includes available asset metadata identifying the asset and targeted audience classification parameters, and the voting database 1324 includes voting information obtained from one or more UEDs for use in targeting assets. The actual assets are generally included in a separate database (not shown). The flotilla constructor 1326 is utilized to populate a break of a programming channel and/or asset channels 1360A-N with selected assets. The channel arbitrator 1328 is utilized to arbitrate the use of limited bandwidth (e.g., available asset channels 1360A-N) when a conflict arises between breaks of two or more supported programming channels. Finally, the inserter 1330 is utilized to insert selected assets or targeted assets into an asset stream (e.g., of a programming channel 1350 and/or one or more asset channels 1360A-N) prior to transmitting the stream across the network interface 1340. As will be discussed herein, the system is operative to provide asset channels 1360A-N to support asset options for breaks of multiple programming channels within the network.

In order to provide asset channels 1360A-N for one or more programming channels, the timing of the breaks on the relevant programming channels is determined. For instance, FIG. 12 illustrates three programming channels that may be provided by the network operator to a household via a network interface. As will be appreciated, many more channels may also be provided. The channels 1202, 1204 and 1206 comprise three programming streams for which targeted assets are provided. Users may switch between each of these channels 1202, 1204 and 1206 (and generally many more) to select between programming options. Each channel 1202, 1204 and 1206 includes a break 1212, 1214 and 1216, respectively, during the programming period shown. During breaks 1212-1216 one or more asset spots are typically available. That is, a sequence of shorter assets may be used to fill the 90-second break. For example, two, three or four spots may be defined on a single channel for a single break. Different numbers of spots or avails may be provided for the same break on different channels and a different number of channels may be used for different portions of the break.

In order to provide notice of upcoming breaks or insertion opportunities within a break, programming streams often include a cue tone signal 1230 (or a cue message in digital networks) a predetermined time before the beginning of each break or insertion opportunity. These cue tone signals 1230 have historically been utilized to allow local asset providers to insert localized assets into a network feed. Further, various channels may provide window start times and window end times during which one or more breaks will occur. These start and end times define an avail window. Again, this information has historically been provided to allow local asset providers to insert local assets into a broadcast stream. This information may also be utilized by the targeted asset system to determine when a break will occur during programming. Accordingly, the system may be operative to monitor programming channels, e.g., 1202, 1204 and 1206, for cue tone signals 1230 as well as obtain and store information regarding window start and end times (e.g., in the schedule database 1320). The available window information may be received from the T&B system and may be manually entered.

Referring again to FIG. 13, the use of signals from the UED 1310 may allow for providing assets that are tailored to current users or otherwise for providing different assets to different groups of users. In this regard, an asset that has targeting parameters that match the classification parameters of the greatest number of users may be provided within the broadcast stream of a supported programming channel 1350 during a break. It is noted that the most appropriate asset may thereby be provided to analog or otherwise nonparticipating users (assuming the voters are representative of the relevant user universe), yielding a degree of targeting even for them. Moreover, some targeting benefit can be achieved for a large number of programming channels, even channels that may not be supported by asset channels with respect to a given break.

Alternatively or additionally, different assets may be provided on the asset channels 1360A-N during the break of a programming channel. During a break where asset channels 1360A-N are available, a UED 1310 of a particular household may, based on a determination implemented at the UED 1310, switch to one of the asset channels 1360A-N that contains appropriate assets. Accordingly, such assets of the asset channel 1360A-N may be displayed during the break. During the break, the UED 1310 may stay on one asset channel 1360A-N (in the case of a break with multiple spots in sequence) or may navigate through the break selecting the most appropriate assets. After the break, the UED 1310 may switch back to the original programming channel (if necessary). This switching may occur seamlessly from the point of view of a user. In this regard, different assets may be provided to different users during the same break. As will be appreciated, this allows asset providers to target different groups during the same break. Further it allows for a network operator to market a single spot to two different asset providers on an apportioned basis (or allow a single asset provider to fill a single spot with multiple asset options). Each asset provider may, for example, thereby pay for an audience that better matches its target.

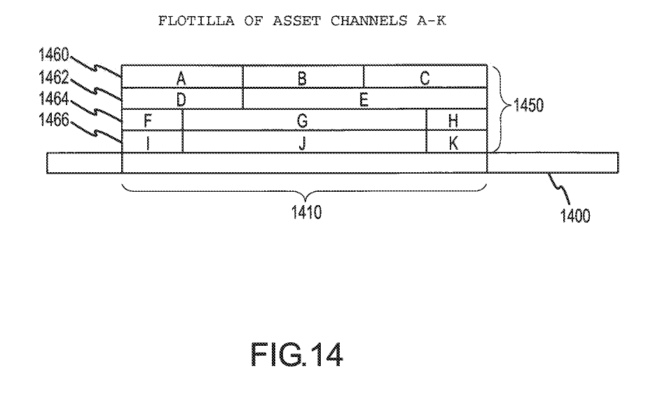

FIG. 14 illustrates the use of four asset channels 1460-1466 for providing a flotilla of assets during a break 1410 of a programming channel 1400. As shown, on each asset channel 1460-1466, the break 1410 may be separated into one or more asset slots that may have different durations. However, in the case of FIG. 14, the start and end times of the asset sets A-C, D-E, F-H and I-K carried by the asset channels 1460-1466 are aligned with the start and end times of the break 1410. Each of the asset channels 1460-1466 may carry an asset that is targeted to a specific audience classification of the users of the targeted channel 1400 or the users of additional programming channels having a break aligned with the break 1410 of the programming channel 1400.

It should be noted that flotillas need not be rectangular as shown in FIG. 14. That is, due to conflicts between breaks or the intermittent availability of certain asset channels as discussed above, the total number of asset channels used to support a given programming channel may change during a break. Each asset channel 1460-1466 includes a different combination of assets A-K that may be targeted to different viewers of the channel 1400 during a given break 1410. Collectively, the assets A-K carried by the asset channels 1460-1466 define a flotilla 1450 that includes assets that may be targeted to different groups of users. The most appropriate assets for a given user may be on different ones of the channels 1460-1466 at different times during the break 1410. These can be delivered to the user by channel hopping during the break with due consideration given to the fact that spots on different channels 1460-1466 may not have the same start and end times. Selection of assets to fill a break of a programming channel, or to fill the available spots within each asset channel of a flotilla may be based on votes of users of the programming channel. That is, assets may be selected by the flotilla constructor 1326 (See FIG. 13) in response to signals received from UEDs 1310 within the network. Such selection may be performed as set forth in co-pending U.S. application Ser. No. 11/332,771, which is incorporated by reference herein.

It is also desirable that each customer premises equipment device be able to navigate across a break selecting assets that are appropriate for the current user. For example, a flotilla may include a number of columns correspondent to a sequence of asset spots for a break. If one column included all assets directed to children, non-children users would be left without an appropriate asset option for that spot. Thus, options for avoiding such situations include making sure that a widely targeted asset is available in each column or time period, or that the union of the subsets defined by the targeting constraints for each asset in a column or time period represents the largest possible subset of the universe of users. Of course, this may conflict with other flotilla construction goals and an optimal solution may need to be arbitrated. In addition, where an issue arises as to which assets to include in a flotilla, the identity of the relevant asset providers may be considered (e.g., a larger volume asset provider or an asset provider who has paid for a higher level of service may be given preference).

To enable the UED to switch to a designated asset channel for a break (or, for certain implementations, between asset options within the flotilla during a break) metadata may be provided in connection with each asset channel(s) and/or programming channel(s). As will be appreciated, each individual asset channel is a portion of an asset stream having a predetermined bandwidth. These asset channels may be further broken into in-band and out-of-band portions. Generally, the in-band portion of the signal supports the delivery of an asset stream (e.g., video). Triggers may be transmitted via the out-of-band portion of a channel. Further, such out-of-band portions of the bandwidth may be utilized for the delivery of the asset option list as well as a return path for use in collecting votes and reporting information from the UED. More generally, it will be appreciated that in the various cases referenced herein where messaging occurs between the UED and a network platform, any appropriate messaging channels may be used including separate IP or telephony channels.

Based on the metadata, the UED may select individual assets or asset sets depending on the implementation. Thus, in certain implementations, the UED may select an asset for the first time-slot of a break that best corresponds to the audience classification of the current user. This process may be repeated for each time-slot within a break. Alternatively, an asset flotilla may include a single metadata set for each asset channel and the UED may simply select one asset channel for an entire break.

Alternatively, asset options may be provided via a forward-and-store architecture in the case of UEDs with substantial storage resources, e.g., DVRs. In this regard, an asset may be inserted into a designated bandwidth segment and downloaded via the network interface to the storage of the UED. Accordingly, the UED may then selectively insert the asset from the storage into a subsequent break. Further, in this architecture, the assets of the stored options and associated metadata may include an expiration time. Assets may be discarded (e.g., deleted) upon expiration regardless of whether they have been delivered. In this architecture, it will be appreciated that the transmission of assets does not have a real-time component, so the available bandwidth may vary during transmission. Moreover, a thirty second asset may be transmitted in five seconds or over thirty minutes. The available assets may be broadcast to all UEDs with individual UEDs only storing appropriate assets. In addition, due to storage limitations, a UED may delete an asset of interest and re-record it later.

In another embodiment, the asset options may be determined remotely at the headend or another remote platform. The selected asset may then be inserted into a customized content stream containing the programming content, and the customized content stream may be unicast directly to the UED or multicast to a selected group of UEDs to receive the same asset. Remote asset determination and delivery reduces the bi-directional messaging traffic required for voting as well as the need for voting logic and substantial asset storage at each UED. As a result, remote asset determination and delivery requires less network bandwidth and facilitates targeted asset delivery to existing equipment at the user's premises.

Contrasting the forward-and-store architecture, the asset channel-hopping and remote delivery architectures require reduced UED storage. In the channel-hopping arrangement, the flotilla is transmitted in synchronization with the associated break and requires little or no storage at the UED. In the remote delivery architecture, the selected asset is integrated with the customized content stream delivered to the UED such that the UED simply plays the transmitted content stream and requires neither channel-hopping nor asset storage. In either case, once an asset is displayed, each UED may provide an asset delivery notification (ADN) to the network platform indicating that the particular asset was delivered. The platform may then provide aggregated or compiled information regarding the total number of users that received a given asset to a billing platform. Accordingly, individual asset providers may be billed in accordance with how many users received a given asset.

B. Dynamic Scheduling

As noted above, the system allows for dynamically inserting assets in support of one or more programming channels based on current network conditions. That is, assets may be selected for programming channels in view of current network conditions as opposed to being selected ahead of time based on expected network conditions. Such a process may ensure that high value air time is populated with appropriate assets. For instance, where current network conditions may indicate that an audience is larger than expected for a current programming period, higher value assets may be utilized to populate breaks. Such conditions may exist when, for example, programming with high asset delivery value and a large expected audience extends beyond a predetermined programming period into a subsequent programming period with low asset delivery value (e.g., a sporting event goes into overtime). Previously, assets directed to the subsequent low value programming period might be aired to the larger than expected viewing audience based on their pre-scheduled delivery times resulting in reduced revenue opportunities. The targeted asset delivery system allows for dynamic (e.g., just-in-time) asset scheduling or, at least, overriding pre-scheduled delivery based on changing network conditions.

As noted, signals from the individual UEDs may be utilized for targeted asset system purposes. However, it will be appreciated that while it is possible to receive vote signals from each UED in a network, such full network ‘polling’ may result in large bandwidth requirements. In one alternate implementation, statistical sampling is utilized to reduce the bandwidth requirements between the network and the UEDs. As will be appreciated, sampling of a statistically significant and relevant portion of the UEDs will provide a useful representation of the channels currently being used as well as a useful representation of the most appropriate assets for the users using those channels.

In order to provide statistical sampling for the network, a sub-set of less than all of the UEDs may provide signals to the network platform. For instance, in a first arrangement, each UED may include a random number generator. Periodically, such a random number generator may generate an output. If this output meets a predetermined criteria (e.g., a number ending with 5), the UED may provide a signal to the network in relation to an option list. Alternatively, the platform may be operative to randomly select a subset of UEDs to receive a request for information. In any case, it is preferable that the subset of UEDs be large enough in comparison to the total number of UEDs to provide a statistically accurate overview of current network conditions. However, where a fully representative sampling is not available, attendant uncertainties can be addressed through business rules, e.g., providing a reduced price or greater dissemination to account for the uncertainty.

As noted, a network operator initially provides an asset option list (e.g., list 1010 of FIG. 10) to at least the UEDs within the network that will vote on assets from the list. Generally, the asset option list includes a list of available assets for one or more upcoming breaks. In this regard, it will be appreciated that a platform within the network may be operative to obtain schedule information for all programming channels that have been identified to be supported by targeted assets. The platform may then use the schedule information to communicate with UEDs over the network interface prior to a break. In particular, the platform may be operative to provide the asset option list to UEDs, for example, periodically.

C. Reporting

It would be possible to implement the targeted asset system of the present invention without receiving reports from UEDs indicating which assets, from among the asset options, were delivered to the user(s). That is, although there would be considerable uncertainty as to what assets were delivered to whom, assets could be priced based on what can be inferred regarding current network conditions due to the voting process. Such pricing may be improved in certain respects in relation to ratings or share-based pricing under the conventional asset delivery paradigm. Alternatively, pricing may be based entirely on demographic rating information such as Nielsen data together with a record of asset insertion to build an estimate of the number of users who received an asset. For example, this may work in connection with programming channels that have good rating information. Moreover, in the remote delivery model, only the selected asset is delivered in the content stream to the UED, so the headend is aware of the assets delivered to the user without receiving a UED report.

However, in connection with the UED selection model, it may be desirable to obtain report information concerning actual delivery of assets. That is, because the asset selection occurs at the UED (in either a forward-and-store or synchronized transmission channel-hopping architecture) improved certainty regarding the size and audience classification values for actual delivery of assets can be enhanced by way of a reporting process. The asset targeting system provides an appropriate reporting process and in this regard provides a mechanism for using such report information to enable billing based on guaranteed delivery and/or a goodness of fit of the actual audience to the target audience. In addition to improving the quality of billing information and information available for analysis of asset effectiveness and return on investment, this reporting information provides for near real time (in some reporting implementations) audience measurement with a high degree of accuracy. In this regard, the reporting may be preferred over voting as a measurement tool because reports provide a positive, after-the-fact indication of actual audience size. Accordingly, such information may allow for improved ratings and share data. For example, such data may be licensed to networks or ratings measurement entities.

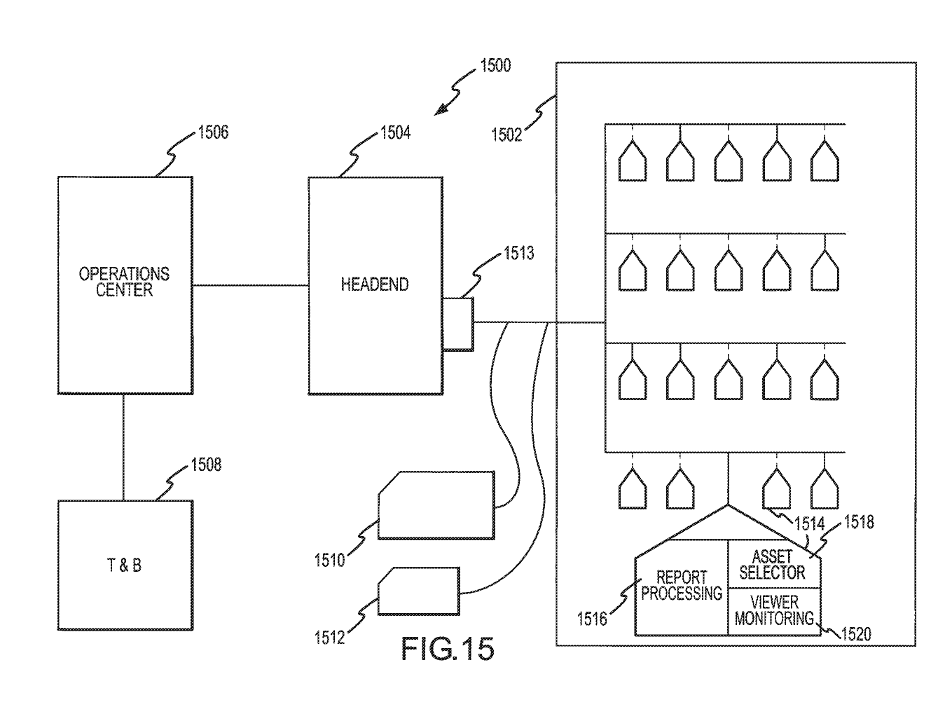

FIG. 15 illustrates a reporting system 1500 in accordance with the present invention. The reporting system 1500 is operative to allow at least some users of a participating user group, generally identified by reference numeral 1502, to report actual asset delivery. In the illustrated implementation, such report information is transmitted to a network platform such as a headend 1504. The report information may be further processed by an operations center 1506 and a traffic and billing system 1508.

More specifically, report information is generated by individual UEDs 1513 each of which includes a report processing module 1516, an asset selector module 1518 and a user monitoring module 1520. The user monitoring module 1520 monitors inputs from a current user and analyzes the inputs to determine putative audience classification parameter values for the user. Thus, for example, module 1520 may analyze a click stream from a remote control together with information useful for matching a pattern of that click stream to probable audience classification parameter values.

These classification parameters may then be used by the asset selector module 1518 to select an asset or asset sequence from available asset options. Thus, as described above, multiple asset sequences may be available on the programming channel and separate asset channels. Metadata disseminated with or in advance of these assets may identify a target audience for the assets in terms of audience classification parameter values. Accordingly, the module 1518 can select an asset from the available options for delivery to the user (s) by matching putative audience classification parameter values of the user to target audience classification parameter values of the asset options. Once an appropriate asset option has been identified, delivery is executed by switching to the corresponding asset channel (or remaining on the programming channel) as appropriate.

The report processing module 1516 is operative to report to the headend 1504 information regarding assets actually delivered and in some implementations, certain audience classification parameter values of the user (s) to whom the asset was delivered. Accordingly, in such implementations, the report processing module 1516 receives asset delivery information from module 1518 and putative audience classification parameter information for the user(s) from the user monitoring module 1520. This information is used to populate various fields of a report file 1510. In other implementations, audience classification information is not included in the report 1512. However, it may be presumed that the asset was delivered to a user or users matching the target parameters. Moreover, such a presumption may be supported by a goodness of fit parameter included in the report. Thus, audience classification information may be inferred even where the report is devoid of sensitive information.

The report files pass through the headend 1504 and are processed by an operations center 1506. The operations center 1506 is operative to perform a number of functions including processing report information for submission to billing and diagnostic functions as noted above. The operations center 1506 then forwards the processed report information to the traffic and billing system 1508. The traffic and billing system 1508 uses the processed report information to provide measurement information to asset providers with respect to delivered assets, to assign appropriate billing values for delivered assets, and to estimate the target universe in connection with developing new asset delivery contracts.

In order to reduce the bandwidth requirements associated with reporting, a statistical reporting process may be implemented similar to the statistical voting process described above. In particular, rather than having all UEDs report delivery with respect to all breaks, it may be desirable to obtain reports from a statistical sampling of the audience 1502. For example, the UED of each user may include a random number generator to generate a number in connection with each reporting opportunity. Associated logic may be configured such that the UED will only transmit a report file when certain numbers are generated, e.g., numbers ending with the digit “5”. Alternatively, the UED may generate reports only upon interrogation by the headend 1504 or the headend 1504 may be configured to interrogate only a sampling of the audience 1502. Such statistical reporting is graphically depicted in FIG. 15 where users selected to report with respect to a given reporting opportunity are associated with solid line links and deselected users are associated with broken line links. Moreover, reporting may be batched such that all reports for a time period, e.g., 24 hours or seven days, may be collected in a single report transmission. Such transmissions may be timed, for example, to coincide with low messaging traffic time periods of the network. Also, the reports from different UEDs may be spread over time.

Billing parameters and goodness of fit information may then be determined based on the report information. The billing parameters will generally include information regarding the size of the audience to whom an asset was delivered. The goodness of fit information relates to how well the actual audience matched the target audience of the asset provider. In this regard, a premium may be extracted where the fit is good or a discount or credit may be applied, or over delivery may be provided where the fit was not as good. Based on this information, the T&B system can then generate billing records. It will be appreciated that such billing reflects guaranteed delivery of targeted impressions with compensation for less than optimal delivery.

As noted above, a platform and associated graphical user interface may be provided for receiving asset contract information. As will be described in more detail below, asset providers can use this interface to specify ad campaign information including targeting criteria such as geographic information, demographic information, run-time information, run frequency information, run sequence information and other information that defines asset delivery constraints. Similarly, constraint information may be provided from other sources. This contract information may also include certain pricing information including pricing parameters related to goodness of fit. Moreover, in accordance with the present invention, report information can be utilized as described above for purposes of traffic and billing. All of this requires a degree of integration between the T&B system, which may be a conventional product developed in the context of the conventional asset delivery paradigm, and the targeted asset delivery system of the present invention, which allows for implementation of a novel asset delivery paradigm.

Among other things, this integration requires appropriate configuration of the T&B system, appropriate configuration of the targeted asset delivery system, and a definition of an appropriate messaging protocol and messaging fields for transfer of information between the T&B system and the targeted asset delivery system. With respect to the T&B system, the system may be configured to recognize new fields of traffic and billing data related to targeted asset delivery. These fields may be associated with: the use of reporting data, as contrasted to ratings or share data, to determine billing values; the use of goodness of fit parameters to determine billing parameters; and the use of report information in estimating the target universe for subsequent broadcasts. Accordingly, the T&B system is configured to recognize a variety of fields in this regard and execute associated logic for calculating billing parameters in accordance with asset delivery contracts.

The targeted asset system receives a variety of asset contract information via a defined graphical user interface. This asset contract information may set various constraints related to the target audience, goodness of fit parameters and the like. In addition, the graphical user interface may be operative to project, in substantially real time, an estimated target universe associated with the defined contract parameters. Consequently, integration of the targeted asset delivery system with the T&B system may involve configuring the targeted asset delivery system such that inputs entered via the graphical user interface are mapped to the appropriate fields recognized by the targeted asset delivery system. In addition, such integration may involve recognizing report information forwarded from the targeted asset delivery system for use in estimating the target universe. Generally, the T&B system is modified to included logic in this regard for using the information from the targeted asset delivery system to project a target universe as a function of various contract information entered by the asset provider via graphical user interface.

### IV. Exemplary Auction System Implementations

Various combinations of the above-described systems and methods may be utilized to provide an auctioning platform for use in auctioning asset delivery options available via the targeted asset delivery systems and methods discussed above. Before discussing the logistics of the auctioning platform, it should be understood that a seller may implement either a pure auctioning system or a hybrid system in which some asset delivery is sold according to the conventional asset delivery paradigm in which a spot in a break on a particular network channel is sold to a single asset provider that provides a single asset for insertion. In parallel, other asset delivery inventory may be sold for targeted spot optimization and/or audience aggregation according to a list price, while still other asset delivery inventory may be sold for targeted spot optimization and/or audience aggregation via one or more auctioning modes and models, as discussed below. A seller may statically allocate asset delivery inventory to one or more of these categories or it may dynamically allocate or reallocate asset delivery inventory as it is sold. One benefit of this ability resides in addressing the issue of “stale assets”, or the idea that certain assets may be sold to a first user within a certain time frame after the asset air date and to a second user for the subsequent time (e.g., when the asset is played from storage at a DVR). In this regard, initial asset delivery inventory relating to the asset may be sold using a non-auctioning aggregation mode, while subsequent asset delivery inventory relating to the asset may be sold using a just-in-time auction.

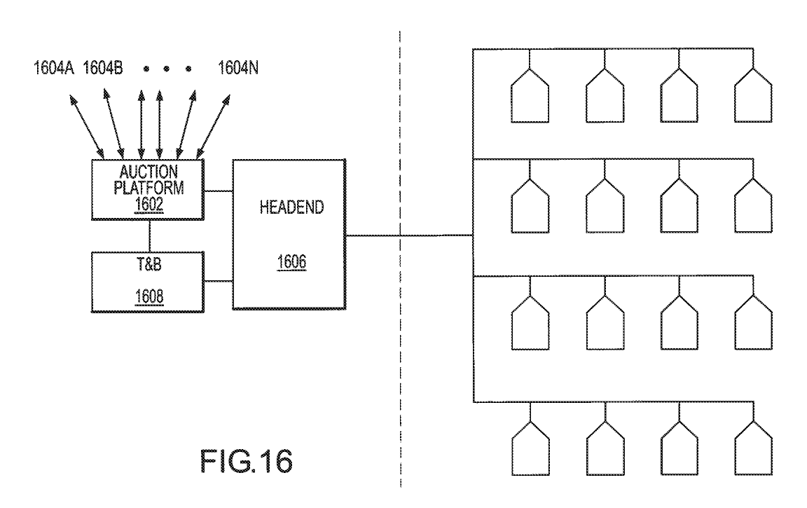

Turning to the auctioning platform, FIG. 16 shows an exemplary auctioning platform 1602 that is accessible by a plurality of asset providers 1604A-N. Such access may be provided using, for example, a graphical user interface, web access, etc. The auctioning platform allows asset providers to bid on asset delivery spots on one or more broadcast channels. The auctioning platform 1602 may allow asset providers to upload content (e.g., assets) to the system such that the content may be inserted into broadcast content. In any case, the auctioning platform 1602 is in communication with a headend 1606 that is operative to implement part of all of the asset targeting systems and methods described above. Further, the auction platform is in communication with a T&B System 1608. The system described herein allows auctioning of specific avails in specific programs or at specific times on specific channels and/or auctioning of viewer impressions. The examples below may be local or national spots. That is, the auctioning technique generalizes to regional, national, and international markets.

Several auctioning modes may be used in auctioning either specific avails in, for example, a spot optimization context (being either a single-asset provider optimization in which one asset provider provides different assets for users watching the same channel or a multiple-asset provider optimization in which different asset providers provide the different assets seen by users watching the same channel) or user impressions in an audience aggregation context. Beyond that, many different auction mechanisms or models may used to determine the winner or winners of each auction and the price that each winning bidder should pay, regardless of the auction mode. For instance, the auction mode may be to auction a single avail to a single winning asset provider, while the identity of winning asset provider and the amount the winning provider will pay may be determined according to an auctioning model in which the highest bidder wins and is required to pay an amount equal to the winning bidder's own bid. Several embodiments of auctioning modes and models/mechanisms are discussed below.

A. Auctioning Modes for Spot Optimization and Audience Aggregation

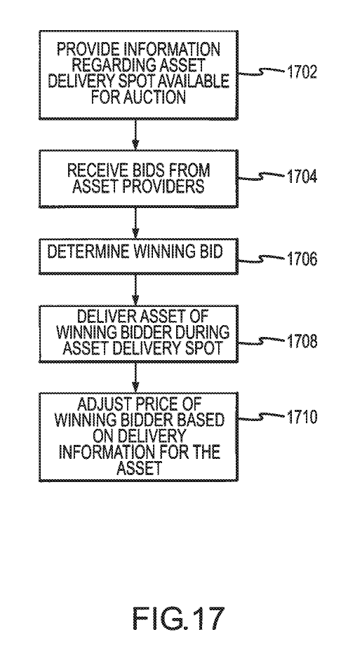

In a first auctioning mode arrangement, a single avail may be auctioned to a single winning asset provider. Initially, as shown in the flowchart presented in FIG. 17, information regarding an asset delivery spot is provided (1702). In this regard, multiple asset providers may bid (1704) on an asset delivery spot. A winning bidder is then determined (1706), and accordingly, an asset of the winning bidder may be delivered (1708) during the delivery spot.

Two examples of auctions where a single avail is provided are set forth below:

1. 1^{st} position in 1^{st} break on “Larry King Live” on CNN at 21:00 Jun. 7, 2010

2. 1^{st} position in 2^{nd} break between 22:00 and 23:00 on CNN Jun. 7, 2010

In instances where the asset to be delivered is already available in the system, an auction need only conclude a small amount of time before the break window starts. When the auction concludes, the winning bidder (and in particular the asset associated with the winning bidder) is communicated to a viewlist composer, which in turn arranges for the asset to be inserted into a broadcast content stream. Such insertion may include replacing the default asset in a customized content stream, transmitting the asset of the winner in separate stream in synchrony with the avail and then causing the UED to switch to the appropriate asset channel and/or transmitting instructions to the UED to play a specific asset during the asset delivery spot, where the asset has been previously stored on its hard disk. The system may or may not return asset delivery notifications (ADNs) from the UED signifying that the asset has been delivered.

In the above description, a bidder places a bid for the specific delivery spot and it is presumed that the bidder has knowledge of one or more characteristics of the audience that will be present. An alternative provides audience characteristics such as ratings information along with the description of what is being sold/auctioned. Extending the above two examples:

1. 1^{st} position in 1^{st} break on “Larry King Live” on CNN at 21:00 Jun. 7, 2010—the national household rating for this program is 1.1

2. 1^{st} position in 2^{nd} break between 22:00 and 23:00 on CNN Jun. 7, 2010—last week's quarter hour ratings averaged 0.7

A further variation takes advantage of the extra information (e.g., ratings, etc.) and allows bidders to bid using familiar price models for advertising sales, including, for example, cost per thousand (CPM) and cost per point (CPP). In this arrangement, a bidder may choose to place bids in total cost mode, CPP mode, or CPM mode. To facilitate such conversion, the ratings estimate is presumed to be correct, so that these bids are easily converted from one to another.

In a further arrangement, the winning bidder (e.g., the buyer) pays only for the assets that are actually delivered (1710). For instance, using returned ADNs, the actual number of impressions (network users who receive a given asset and are within the specified demographic of the bidder) may be calculated and the winning bidder may be asked to pay for them proportionally based on the original rating. Such a mode may be referred to as “guaranteed impressions.” For example, in a market with 1,000,000 households, all of which are reached by a system operator, a broadcast program is estimated to have a rating of 2.0 (meaning it will reach 20,000 households). If a bidder wins with a bid of $300 for the spot (which in the other methods described would be bidding $150 per point (in CPP mode) or $15 per thousand (in CPM mode)), then the bidder may expect to get 20,000 impressions verified by ADNs. What the bidder actually pays is $300*(actual audience size/20,000).

This mode may require the winning bidder to pay more or less than it originally bid for the spot. To provide the winning bidder some certainty, it may be desirable to cap the overage that the winning bidder would pay. For instance, it may be agreed in advance that a winning bidder will never pay an overage that exceeds, for example, 20% of their actual bid amount, even if a bigger audience appears. Further, if the actual audience is within some percentage of the original estimate, for example 5%, then the winning bidder may pay the original estimate. Ratings information may come from an external source like Nielsen or it may be generated using ADNs or votes returned from UEDs, or it could be a combination of such information.

While the examples above discuss placing a single asset into an avail (e.g., asset delivery spot), this avail could of course be used for a spot-optimized spot with several targeted alternatives being supplied during the avail because of targeting performed at the UEDs or a remote platform. That is, an asset provider could bid and buy the spot, and then provide three differently targeted assets to be run in the spot with the UEDs of the network users or the remote platform picking the particular asset for the UED of each user for that UED. In such an arrangement, a multi-spot premium that is over and above the bid price may be charged for such a service.

In another arrangement, multiple avails may be auctioned to a single winner. For instance:

1. All of the 1^{st} position in 1^{st} breaks on “Larry King Live” on CNN at 21:00 for the week of Jun. 12 to Jun. 18, 2010 (7 Avails) total gross rating points 7.7

2. 1^{st} position in 2nd break between 22:00 and 23:00 on CNN for the week starting Jun. 19, 2010—average gross rating points from last week 4.9

3. 20 breaks (described here . . . ) on Network A in the next week. Average rating for this network is 0.3, with a ratings guarantee of 6.0 gross rating points.

4. In the week of Jun. 19, 2010 breaks in the following 30 programs (list follows . . . ), which total 20.0 gross rating points.

In this arrangement, the auction may need to conclude before the first break of the group. By grouping several programs together, the ratings guarantee mechanism may be more easily implemented as the risks associated with audience variability from day to day are reduced in this case. As well, by picking a pool of advertising on an unrated network, calculating a likely overall rating, and making a ratings guarantee, becomes less risky.

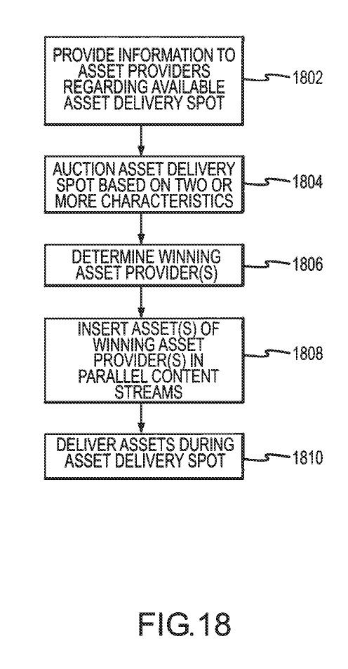

In another arrangement, as illustrated in FIG. 18, a single avail may be auctioned to multiple winners. That is, as the spot optimization system can provide multiple advertising options at one time, those multiple options for a single asset delivery spot may be sold to multiple bidders. Examples of a multiple option single avail auction:

1. 1^{st} position in 1^{st} break on “Larry King Live” on CNN at 21:00 Jun. 7, 2010, two winners each getting 50% of the audience

2. 1^{st} position in 2^{nd} break between 22:00 and 23:00 on CNN Jun. 7, 2010, three winners each getting 33.3% of the audience

Initially, information associated with the avail is provided (1802) to the asset providers. Provision of information may include providing one or more audience characteristics. The asset delivery spot is then auctioned (1804) to the asset providers based on two or more characteristics (e.g., a ½ audience share, demographics, etc.). Winning bidders are determined (1806). Assets of the winning bidders are inserted (1808) into parallel content streams and delivered (1810) during the asset delivery spot (e.g., simultaneously). In this regard, a first asset may be delivered to a first portion of a broadcast audience, and a second asset may be delivered to a second portion of the broadcast audience.

As will be appreciated, multiple options for a single avail may require either simultaneous synchronized transmission of the assets or playback from local storage. As discussed above, the UEDs may pick which asset to show based on, for example, random number generation. For instance, a random number generator at each UED may generate real numbers in the range [0.0,1.0]. All UEDs generating a number in the range [0, 0.5] show a first asset and all UEDs with a number in the range [0.5, 1] show a second asset. In this scenario, the audience may be split between two different winners. Of course, the auction changes subtly to accommodate multiple winners (e.g., two or more).

In a further arrangement, the audience for a specific program may be identified by demographics and each of those demographic may be auctioned separately. This may represent a rating for specific demographic group, rather than a household rating. An example auction would be

1. In 1^{st} position in 1^{st} break on “Larry King Live” on CNN at 21:00 Jun. 7, 2010:
1a. Men 55+—rating 1.2

1b. Women 55+—rating 1.8
1c. Remaining audience—rating 1.0

Here, a bidder would bid on one or more of these demographics, which may each be sold in a separate auction. A bidder may choose to compete for more than one of the demographics, and will likely pay a differing amount for each demographic won. Note that in this example, the demographics do not overlap. However, this is not an absolute requirement, as a mechanism for randomly assigning a given demographic group to multiple winners with a randomized delivery may be implemented. Such a mechanism may be used to split overlapping demographic categories between winning bidders.

This may further be generalized to split the audience of each program auctioned into, for example, the 16 age/gender ranges that Nielsen uses for demographic rating. Each of these ranges is non-overlapping (the age ranges are 2-11, 12-17, 18-24, 25-34, 35-49, 50-54, 55-64, 65+ and are calculated for both genders). A bidder may compete in separate auctions for each demographic of interest. Note that in many programs the rating for a given category may be zero or nominal, and thus, no auction may take place for such a demographic.

In a further arrangement, a bidder is allowed to specify an all-or-nothing bid. That is, the bidder's bid is allowed to be conditional on winning each of the bidder's auctions, or even some specified fraction of its bids. This may be dealt with by determining a “potential winner” by deciding if the bidder's bid criteria has been met and if not, knocking the bidder out of the auction and elevating the second place bidder in all of the auctions the potential winner has been knocked out of. This style of auction may be implemented in a GUI that would allow the bidder to easily place bids and establish various limits across a group of bids.

In another arrangement, multiple avails may be auctioned to multiple winners. For instance, when auctioning off a group of similar avails, it may be desirable to allow bidders the opportunity to bid on subsets of the whole group. In this kind of auction, the avails may be similar. Consider an auction for basketballs. There are 20 for sale; a bidder can bid for as many as it wants. This is easy for a bidder. But an auction for 20 balls where there are baseballs, basketballs, golf balls and tennis balls presents a problem for the bidders. In this instance, it may be better to run different auctions for different types of balls. Examples of multiple avails multiple winners auctions:

1. 14 avails in Larry King Live for the week of June 18th. Note that two avails per program are offered. Bidders may bid on any number of avails. Average rating points per avail are 1.1. No impression guarantee provided on purchases of less than 7 avails.

2. 42 prime-time avails on OLN for the week of June 18th. Two avails per hour are offered between 7 pm and 10 pm. Bidders must bid for a minimum of 10 avails to get an impression guarantee.

Again the auction changes to accommodate multiple winners with the high bidder being allocated its share until all slots are used up. Various pricing mechanisms are possible. Alternatives, discussed in detail below, include each winner paying what it bids (per avail), all winners paying the same amount per avail that the lowest bidding winner pays, or all winners paying a penny more than the high loser per avail.

In the same manner as described when auctioning a single avail to multiple winners, the demographics for the group of programs may be broken apart and each group auctioned separately. These individual auctions can be run either as single winner auctions (in which case the programs need not be similar) or they can be run as described above with bidders bidding on portions of demographics pools (either by impressions or rating points). In this case, it may be desirable that the programs are similar or have similar audiences. In practice, this may mean groups of the same programs or perhaps large groups of programs on specialty networks.

Example auctions where multiple avails are sold by demographics:

1. 56 avails in Larry King Live for the broadcast month of July 2010 broken into the following demographic groups:
1a. Men 55+—total gross rating points 67
1b. Women 55+—total gross rating points 101
1c. Remaining audience—total gross rating points 56

A bidder may bid for any number of ratings they desire. Further, to facilitate the process, the number of gross rating points bid for may be exceeded by up to 2 ratings points (e.g., if a bidder bids for 17 points, they may win 19 points).

All of the systems, to the extent that they use ratings information, may get their ratings information from an external source such as Nielsen. An alternative source of ratings information is for the system to use ADNs to build up a model for program ratings. By monitoring ADNs and the targeting of assets delivered to those audiences, it is possible to make inferences about the size and demographics of audiences. These inferences can be accumulated and used to predict program ratings. In another arrangement, a system similar to voting that returns information about the types of people that are currently viewing is used to provide a real-time estimate of the audience for each asset. This information could be used just-in-time to determine auction winners.

Users of this system may not want to manage hundreds of auctions on an auction-by-auction basis. Accordingly, an interface that allows an asset provider to automate the process of finding appropriate auctions and then bidding on them is provided. One component of this system is a search mechanism that helps users find auctions that meet the user's various criteria such as household or demographic rating information, current bid amounts and historical bid amounts. Another component of this system is an automatic bidder that automatically submits bids on specific types of avails. For instance in a system where individual avails are split apart by demographics, the automated bidding system may take bids such as “please bid up to $150 CPM on any men 18-24 demographics where the rating is between 0.5 and 1.0.”

The core concept for this mode is to integrate an aggregation mode with a just-in-time auction. The key for an aggregation mode is that the asset provider/bidder describes a set of target attributes for consumers that they wish to reach and then the system helps them reach that audience across a group of channels 24 hours a day (or other time frame as set forth by the bidder).

A bidder begins the purchase process by using a GUI (or other system-to-system interface) to specify the parameters for an aggregated auction offer. The parameters for an offer allow the auction system to make automatic bids on behalf of bidders. The parameters may be specified in supersets/subsets in that each superset of parameters may include one or more subsets. For instance, a user may specify a superset of parameters that includes start and end dates for an asset campaign. The superset may include a subset that indicates day of week and time of day limitations that apply within the running time of the campaign. Exemplary parameters include:

1. Targeting criteria—many different targeting mechanisms may be used. A given ad insertion implementation may support only a subset (or a superset) of the following:
UED classifications (e.g., age, gender, household income)
Start and end time and date for campaign
Time of day limitations
Day of week limitations
Geographic restrictions
Household tags (determined using UED identifier lists from the headend that directs the UED to select a particular asset or type of asset)
Network inclusions and exclusions
Program rating inclusions and exclusions
Program title word inclusions and exclusions
Keyword searches
Commodity codes
Minimum separation

2. Maximum impressions—an asset provider specifies a total number of impressions that they want to buy. Once this total is reached the offer is deemed fulfilled and automatic bidding stops.

3. Maximum price per impression—an asset provider specifies the maximum amount of money that the automatic bidding system should bid per impression.

4. Maximum cost—an asset provider specifies the maximum amount of money that the buyer is prepared to pay for the contract. Once this amount of money has been expended on the campaign, the offer is deemed fulfilled and automatic bidding stops.

5. Pacing—the asset provider may specify pacing constraints that specify the maximum amount of money the provider is willing to pay for a given time period. These can be specified, for example, as daily, weekly or monthly pacing amounts. In any given time period if the specified total is reached then automatic bidding is suspended until the next period starts.

Note that all of the above may be changed at any time, although there may be a delay in implementing some of the changes. For instance, in a given system it might take up to 24 hours to make changes to targeting, whereas updates to maximum price per impression might take effect nearly instantly. Other changes might take effect only once per day at a given time of day (for instance changes to pacing may take effect at 2 am each morning). A given campaign may also be suspended and resumed (that is, automatic bidding stops until the campaign is resumed).

Asset providers bid on targeted impressions to be delivered to audiences. These impressions may be sold by running an automatic auction before each break occurs on a network for which auctioning insertion is supported. In general, an asset provider will need to win a number of auctions to satisfy its impression goals. Each asset provider may enter the auction for each possible avail or asset providers may elect to enter only selected auctions.

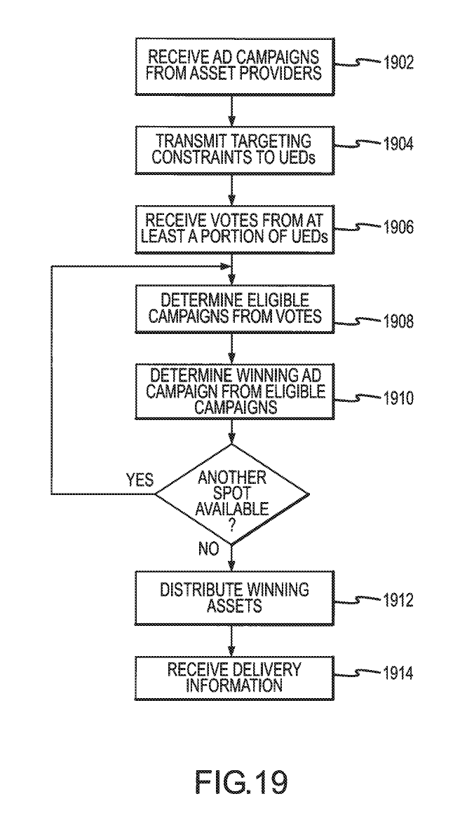

One exemplary process for implementing the just-in-time automated auction employing UED voting is provided in relation to FIG. 19. Initially, the auction platform receives (1902) asset campaigns from asset providers. These campaigns may be received over a considerable period of time and/or on an ongoing basis. On a periodic basis, a list of the targeting constraints for all of the active campaigns is transmitted (1904) to all UEDs in the system. The set of constraints that are transmitted to the UEDs include those constraints that can only be evaluated in the UEDs. Shortly before the avail window on a given network occurs, the system asks UEDs, including DVR UEDs, to “vote.” At least a statistical sample of UEDs tuned to the network in question submit votes that list one or more, e.g., the complete set, of campaigns that the UEDs matches at the moment of the vote. The auctioning platform collates the votes that are received (1906) from the UEDs.

The system may evaluate some of the targeting criteria in the headend and/or auctioning platform and determine (1908) that certain campaigns are not eligible to be played even though some UEDs vote for them (for instance, program rating exclusion might be determined only in the headend). Votes for these campaigns are eliminated. The size of audience for each eligible campaign is estimated from the collated votes and the voting sampling criteria. The auction system uses the information from the audience size estimation and the offer parameters to determine (1910) the winner of the auction. A price per impression is also determined if an additional parallel distribution opportunity is available, then all votes originating from a UED that has already voted for a winning campaign are eliminated, the remaining votes are recollated and steps 1906 to 1910 are repeated until there are no remaining distribution opportunities.

Provisional updates to the impression totals, and cost totals for all of the winning campaigns are accounted for. All of these provisional updates are tracked in a manner that allows them to be “backed out”. When the cue signal arrives, the set of assets associated with the winning campaigns are distributed 1912 in synchronized parallelism with the avail. Each UED tuned to the channel may pick an asset for insertion, and then each UED, or a statistical sample of UEDs, may report which of the assets that it delivered to the headend (e.g., Asset Delivery Notifications or ADNs). The winning bidders may then be charged based on the actual number of impressions that were delivered. To do this, the actual number of impressions delivered is multiplied by the cost per impression calculated for this campaign during the auction. The provisional update for each winning campaign is backed out and the actual impression count and costs are used to update the totals.

The noted automated auctioning mode uses a voting mechanism to estimate the size of an audience. As a UED evaluates all of the UED dependent parameters to determine a match, each vote provides a very accurate estimate of the campaign matching the UED audience for the impending break. However, there are alternative mechanisms that could provide an estimate of the size of audience for a particular campaign for an upcoming break. The accuracy of these mechanisms will depend on the set of targeting mechanisms available in the system. Alternatives include:

1. Use external data sources that include television ratings and census data

2. Use historical ADN data to build up a statistical model of viewership

3. Operate the voting system to periodically survey the system for information about current viewers (as opposed to eligible campaigns). To differentiate this mechanism from voting we will call this a “UED census”

Notably, while the automated auctioning mode provides for very accurate charging, in that the system may charge winning bidders only for actual advertising delivered, in practice, the estimate system employed in the voting step may accurately estimate audience size, particularly if the re-voting mechanism described below is employed. In this instance, the delivery notification system need not be implemented and the voting estimate may be used in the final price computations.

As described above, voting can return a binary match Yes/No match indication. Some of the targeting mechanisms do have binary resolutions (for instance those based on geography), however other mechanisms (for instance the age and gender of the current audience that is determined by a classifier system) have probabilistically determined match criteria. Another voting mechanism is to return the probability (i.e., goodness of fit) that a particular campaign matches. The list that is returned might include a probability for each campaign, or it might return indications for only those campaigns where the probability exceeds a given threshold. Collating the probabilistic votes may be done in a statistical manner that generates a probability distribution describing the likelihood of the size of an audience for each campaign that was voted for. Likewise that distribution may be used to calculate an expected value for the revenue that would be derived from each campaign.

As the time between voting and the actual insertion of advertising increases, so increases the likelihood that the size and character of the audience has changed. If the difference is only a few minutes (e.g., 2 or 3 minutes), and there hasn't been a program change, then the difference is likely small. If, on the other hand, the difference is 15 or 20 minutes, it is quite likely that there has been a substantial change. Two alternatives are presented for dealing with the change of audience. The first is to build a probability model of how an audience changes over time, and use techniques such as non-linear filtering to predict the likely changes in the audience. A second alternative is to periodically (for instance every 5 minutes) carry out a revote, and if the result of the new vote is substantially different from the previous vote, carry out a new auction. Some care needs to be taken to avoid conditions where the actual break happens during the re-vote and re-auction process. In such an instance where a break occurs before a re-auction is completed, previous auction results may be utilized to identify winning bidders and select assets for insertion.

When multiple simultaneous assets are provided to a UED or UEDs, the UED must pick one of these assets to deliver. Alternatives for selecting assets include first match and best match. In first match mode, asset choices are ordered in the same order in which their respective auctions were won and then the UED selects the first one that is a reasonable match. In best match mode, the UEDs current estimate for a best match among the alternatives is chosen.

B. Auctioning Models

Regardless of the auctioning mode employed (e.g., single asset for single avail, multiple assets for multiple avails, etc.), the auctioning platform is responsible for determining the winner or winners of each auction and the price that each winning bidder should pay. In circumstances where there are multiple winners, it may be desirable to incrementally determine winners and then determine the price that they pay after all winners have been determined.

The auctions described in relation to specific avails take place over a period of time and allow a bidder to change a bid during the course of the auction. This is because the goods being sold (the avails) can be determined ahead of time. However, in the case of auctions run in aggregation mode, this may not be possible because the number of real-time viewers is a critical component in the description of the audience, and that number is not known until a very short period of time before the asset is distributed. Complicating matters further, when multiple options or slots are being auctioned, the number of viewers for a given slot may be highly dependent on viewers for the other slots. Consider the following Table 1, in which positive votes are indicated with a 1:

TABLE 1
UED Votes.

| | Asset A | Asset B | Asset C | Asset D |
|---|---|---|---|---|
| UED 1 | 1 | | 1 | |
| UED 2 | 1 | | | 1 |
| UED 3 | | 1 | 1 | |
| TOTAL | 2 | 1 | 2 | 1 |

If the bidder owning Asset A wins the auction, then Asset B continues to hold one vote but Asset C is reduced from two to only one vote and Asset D has no votes. If on the other hand the bidder owning Asset C wins the auction, then Asset D continues to hold one vote but Asset B is reduced to no votes and Asset A is reduced to one vote. The important observation is that the auction for the second asset delivery option or slot (e.g., parallel distribution opportunity) in the flotilla changes quite dramatically. Consequently, when the auction runs entirely in an automated mode, the bidders may not have an opportunity to change their bids during the bidding process (although they may be able to change there bids up to the moment that the auction is conducted).

Different auctioning models may perform better than others in various auctioning environments. For instance, a first auctioning model may outperform a second auctioning model in circumstances where there is a high demand, or a large number of assets competing for a flotilla slot or asset delivery option, while a third auctioning model may outperform both the first and second models in instances where the demand is low. In this regard, there are several environmental auctioning factors that influence which auctioning model should be used for any given auction. As previously mentioned, one exemplary environmental auctioning factor is the demand market within which the auction is being performed. Certain auctioning models may perform comparatively better or worse when there are more or fewer assets competing for a flotilla slot or asset delivery option. Another environmental auctioning factor highlights the amount of variance between the asset providers' bids. That is, an auctioning environment in which each bidder places a similar value on each impression may be better suited for a different auctioning model than an auctioning environment in which bidders' value impressions vary significantly. Audience size, or the number of users or viewers available to be targeted, as well as the number of flotilla slots or asset delivery options available to be auctioned, also impact the selection of an appropriate auctioning model. In addition, a seller may consider an execution time, or how fast the auction can execute, in determining which auctioning model provides the best fit. Another environmental auctioning factor may include how easily an auctioning model can be explained to bidding asset providers. In the same vein, it may be helpful to consider the identities of the asset providers so that the seller can understand their relative auctioning sophistication and ability to fully understand each auctioning model.

As discussed above, the auction for the second asset delivery option or slot may take place in a different auctioning environment than the auction for the first slot. For example, once the first slot is filled, the viewers captured by the winning asset will no longer be considered in auctions for subsequent slots. Similarly, once the winning asset has been added to the flotilla, the demand for the next slot is reduced. This type dynamic change in environmental auctioning factors relating to the audience size, demand, variance, and so on, may alter the inputs to these factors to a degree that a subsequent analysis of the factors results in a different auctioning model being applicable to the auction for the next slot. In this regard, it may be advantageous to determine auctioning models as the auction progress, or to determine an appropriate auctioning model prior to running the auction for each flotilla slot.

Notably, in many cases, the auctioning model selected for a particular auction may be based on the auctioning model that will maximize the seller's revenue. That said, auctioning models may be selected based on any other appropriate criteria, including legal, contractual, competitive, or business policy concerns.

The same concerns may apply to constructing a pool of assets that will be allowed to compete for a flotilla slot. That is, several different asset delivery constraints may apply to limit the assets/asset providers that are allowed to participate in an auction for any slot or asset delivery option in a given flotilla, as discussed in U.S. application Ser. No. 09/877,718, entitled “ADVERTISING DELIVERY METHOD,” filed on Jun. 8, 2001, the contents which are incorporated by reference herein as if set forth in full. For instance, contractual terms between the seller and one or more asset providers may place certain competitive constraints on flotilla construction. In one example, an asset provided by Pepsi may not be allowed to occupy a flotilla slot directly following an asset provided by Coca-Cola. In application, once Coca-Cola wins the first flotilla slot, then an application of one or more asset delivery constraints would prevent any asset submitted by Pepsi from competing in the auction for the second flotilla slot. In another example, the seller may enter into a contractual agreement with an asset provider to restrict the mode of advertising. For instance, the seller may enter into a contract with Hillary Clinton stipulating that Clinton campaign advertisements will not air on the Fox News Channel. Other asset delivery constraints may encompass legal restrictions, such as limiting the times, frequencies, and/or the network channels upon which certain assets may appear. For instance, FCC regulations may prevent assets containing age-sensitive content (e.g., assets relating to male/female sexual dysfunction, adult phone lines, etc.) from appearing during certain daytime hours or on certain network channels. The asset delivery constraints may be applied to prevent such assets from entering the pool of assets that compete for flotilla slots during the restricted hours or on the restricted channels. The asset delivery constraints may also be based on policy concerns, business considerations, or any other appropriate criteria for limiting the asset pool.

Similar to the analysis of the environmental auctioning factors, discussed above, the asset delivery constraints may be analyzed and/or applied to establish a pool of assets to be available for auctioning prior to the auction associated with each flotilla slot. That is, the asset delivery constraints may be used to establish the pool of assets to be auctioned before the appropriate auctioning model is selected for each flotilla slot.

With this contextual background in mind, several exemplary auctioning models are described below.

High Bidder Wins

In this auctioning model, an offering price for each asset is calculated as follows: the maximum bid per impression, or CPI bid, for an asset is multiplied with the estimated audience size to determine the maximum offering prize (Z value). The largest legal offering price wins the auction. In the case of a tie, one of the bidders may be picked at random or another tie-breaking mechanism may be implemented. The price per impression paid is the maximum offering price, or the largest Z value.

The term “legal bid” or “legal offering” is used to describe a bid that does not violate a bidder's complete bid, which includes the total amount the bidder is willing to pay and any constraints on the bid. For instance, if a bidder has said the maximum it is willing to pay for an ad campaign is $1,000 and it has already accumulated $990 in advertising, then any subsequent bid of less than or equal to $10 is legal, but any larger bid is not. One novel consequence of this auction model is that all campaigns compete for every avail, and in particular, multiple campaigns for the same bidder may end up bidding against each other. Special rules may be implemented to prevent this from happening. In particular, once a particular bidder wins a bid, then for the current auction other bids from that buyer could be considered illegal.

A first scenario, Scenario 1, is presented in Table 2 below. Scenario 1, which includes five asset options and only one parallel content distribution opportunity available in a given avail (i.e. a flotilla having two asset slots and one column), yields the following two exemplary tabulations of the number of impressions available to each asset provider. As discussed above, the number of available impressions may be determined in several ways. For instance, it may reflect votes cast by the UEDs or, alternatively, a remote determination made at the headend or other remote platform (a 1 indicates a positive vote). For ease in explanation, the description may refer to each available impression as a vote or an impression. Notably, the voting tabulation shown represents a statistical sampling of 5% of the total UED population.

TABLE 2
First tabulation of available impressions for Scenario 1.

| | | Impressions for Assets | | | | |
|---|---|---|---|---|---|---|
| Scenario 1 | | A | B | C | D | E |
| UED | 1 | 1 | 1 | 1 | 1 | 1 |
| | 2 | 1 | | | | 1 |
| | 3 | 1 | 1 | 1 | 1 | 1 |
| | 4 | | 1 | 1 | | |
| | 5 | | | 1 | | 1 |
| | 6 | | | | 1 | |
| | 7 | | 1 | 1 | | |
| | 8 | | 1 | 1 | | 1 |
| | 9 | 1 | | | 1 | 1 |
| | 10 | 1 | | 1 | | 1 |
| | 11 | | 1 | 1 | | |
| | 12 | 1 | 1 | | 1 | 1 |
| | 13 | | | 1 | | 1 |
| | 14 | 1 | 1 | 1 | | 1 |
| | 15 | | | 1 | 1 | |

| | | | | | |
|---|---|---|---|---|---|
| TOTAL | 7 | 8 | 11 | 6 | 10 |

Supposing the winning bid is asset C, all votes associated with asset C are removed and a new total is computed, as shown in Table 3:

TABLE 3
Second tabulation of available impressions for Scenario 1.

| | | Impressions for Assets AFTER C is removed | | | | |
|---|---|---|---|---|---|---|
| Scenario 1 | | A | B | C | D | E |
| UED | 1 | | | | | |
| | 2 | 1 | | | | 1 |
| | 3 | | | | | |
| | 4 | | | | | |
| | 5 | | | | | |
| | 6 | | | | 1 | |
| | 7 | | | | | |
| | 8 | | | | | |
| | 9 | 1 | | | 1 | 1 |
| | 10 | | | | | |
| | 11 | | | | | |
| | 12 | 1 | 1 | | 1 | 1 |
| | 13 | | | | | |
| | 14 | | | | | |
| | 15 | | | | | |

| | | | | | |
|---|---|---|---|---|---|
| TOTAL | 3 | 1 | 0 | 3 | 3 |

Table 4 applies an exemplary set of CPI bids to illustrate the application of the Highest Winning Bidder auctioning model to the tabulation of available impressions of Scenario 1. Note that since the assumption in this example is that 5% of the UEDs vote, the estimated audience is 20 times this total vote for each asset. Here, the bidder with the highest Z value is the bidder associated with asset C ($66.00). Thus, the owner of asset C wins the first flotilla slot and pays a CPI of $0.30:

TABLE 4
Winner of the first asset slot under the
High Bidder Wins auctioning model.

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI Bid | 0.30 | 0.25 | 0.30 | 0.10 | 0.25 |
| Offering Price (Z) | $42.00 | $40.00 | $66.00 | $12.00 | $50.00 |
| WINNER | | | WINS | | |

As shown in Table 5, an alternative set of CPI bids can yield a different winner, which in this case is the bidder associated with asset D, who will pay a CPI of $0.60.

TABLE 5
Alternate winner of the first asset slot under
the High Bidder Wins auctioning model

| | Asset | | | | |
|---|---|---|---|---|---|
| | A | B | C | D | E |
| Total Impressions | 7 | 8 | 11 | 6 | 10 |
| Estimated Audience | 140 | 160 | 220 | 120 | 200 |
| CPI Bid | 0.30 | 0.25 | 0.30 | 0.60 | 0.25 |
| Offering Price (Z) | $42.00 | $40.00 | $66.00 | $72.00 | $50.00 |
| WINNER | | | | WINS | |

The Highest Winning Bidder auction is repeated for each parallel distribution opportunity, and there is no adjustment in price.

After asset C is chosen to fill the first flotilla slot (Table 4), the votes are recounted as demonstrated in Table 3. Table 6, below, illustrates the determination of the second winner, which in this case is the owner of asset A, who will pay a CPI of $0.30

TABLE 5
Winner of the second asset slot under
the High Bidder Wins auctioning model.

| | Asset | | | | |
|---|---|---|---|---|---|
| | A | B | C | D | E |
| Total Impressions | 3 | 1 | 0 | 3 | 3 |
| Estimated Audience | 60 | 20 | 0 | 60 | 60 |
| CPI Bid | 0.30 | 0.25 | 0.30 | 0.10 | 0.25 |
| Offering Price (Z) | $18.00 | $5.00 | $— | $6.00 | $15.00 |
| WINNER | WINS | | | | |

High Bidder Wins—Vickery Pricing

For each asset an offering price or Z value is calculated as follows: the CPI bid associated with the asset is multiplied with the estimated audience size. The largest legal offering price wins the auction, and, in the case of a tie, one of the bidders may be picked at random or another basis, or the avail may be split. The estimated total price that the winning bidder will pay is the next highest legal offering price. The winning price per impression is calculated by dividing the next highest legal offering price by the estimated size of the winning asset's audience.

Using the votes from Scenario 1 (Tables 2-3) as an example, the winner is again the owner of asset C, which has the largest Z value of $66.00. However, the owner of asset C will pay the next highest legal offering price divided by the estimated audience for asset C, or $50/220=$0.227 CPI.

TABLE 6
Winner of the first asset slot under the High
Bidder Wins, Vickery pricing auctioning model.

| | Asset | | | | |
|---|---|---|---|---|---|
| | A | B | C | D | E |
| Total Impressions | 7 | 8 | 11 | 6 | 10 |
| Estimated Audience | 140 | 160 | 220 | 120 | 200 |
| CPI Bid | 0.30 | 0.25 | 0.30 | 0.10 | 0.25 |
| Offering Price (Z) | $42.00 | $40.00 | $66.00 | $12.00 | $50.00 |
| WINNER | | | WINS | | |

This auction is repeated for each parallel distribution opportunity and there may be no adjustment in price.

High Bidder Wins—All Pay Same Total Price

Under this model, an offering price or Z value is calculated as follows for each asset: the CPI bid associated with the asset is multiplied with the estimated audience size. The largest legal offering price wins the auction. Final price calculation may be completed after all winners for a given flotilla are determined.

The auction is repeated for each parallel distribution opportunity. Once all winners have been determined, then the offering price of the lowest winning bidder is used as the estimated price. The winning price per impression for each bidder is calculated separately for each as by dividing the estimated price of the lowest winning bidder by the estimated size of each particular winning bid's audience.

Applying this method to the votes of Scenario 1 and assuming a parallel distribution opportunity for two simultaneous assets, the winner of the first slot will be the owner of asset C (Table 7) and the winner of the second slot will be the owner of asset A (Table 8). Each will pay an amount equivalent to the offering price of the lowest winning bidder, or $18. That is, owner of asset C will pay $18/220=$0.0818 CPI and the owner of asset A will pay what it bid, or $0.30 CPI.

TABLE 7
Winner of the first asset slot under the High Bidder
Wins - All Pay Same Total Price auctioning model.

| | Asset | | | | |
|---|---|---|---|---|---|
| | A | B | C | D | E |
| Total Impressions | 7 | 8 | 11 | 6 | 10 |
| Estimated Audience | 140 | 160 | 220 | 120 | 200 |
| CPI Bid | 0.30 | 0.25 | 0.30 | 0.10 | 0.25 |
| Offering Price (Z) | $42.00 | $40.00 | $66.00 | $12.00 | $50.00 |
| WINNER | | | WINS | | |

Table 8 shows the results of the second auction after C is removed.

TABLE 8
Winner of the second asset slot under the High Bidder
Wins - All Pay Same Total Price auctioning model

| | Asset | | | | |
|---|---|---|---|---|---|
| | A | B | C | D | E |
| Total Impressions | 3 | 1 | 0 | 3 | 3 |
| Estimated Audience | 60 | 20 | 0 | 60 | 60 |
| CPI Bid | 0.30 | 0.25 | 0.30 | 0.10 | 0.25 |
| Offering Price (Z) | $18.00 | $5.00 | $— | $6.00 | $15.00 |
| WINNER | WINS | | | | |

High Bidder Wins—All Pay Same Price Per Impression

Under this model, an offering price or Z value is calculated as follows for each asset: the CPI bid associated with the asset is multiplied with the estimated audience size. The largest legal offering price wins the auction, in the case of a tie, one of the bidders is picked at random. Final price calculation may be done after all winners for a given flotilla are decided. The auction is repeated for each parallel distribution opportunity. Once all winners have been determined, then the lowest price paid per impression by a winning bidder is the winning price per impression for each bidder.

Again applying this model to the votes of Scenario 1, and assuming a parallel distribution opportunity for two simultaneous assets, the winners of the first and second flotilla slots are the owners of asset C and asset A, respectively, as shown in Tables 9 and 10 below. Each winning bidder will pay the CPI associated with the lowest winning bidder, which in this case is $0.30.

TABLE 9
Winner of the first asset slot under the High Bidder Wins -
All Pay Same Price Per Impression auctioning model.

| | Asset | | | | |
|---|---|---|---|---|---|
| | A | B | C | D | E |
| Total Impressions | 7 | 8 | 11 | 6 | 10 |
| Estimated Audience | 140 | 160 | 220 | 120 | 200 |
| CPI Bid | 0.30 | 0.25 | 0.30 | 0.10 | 0.25 |
| Offering Price (Z) | $42.00 | $40.00 | $66.00 | $12.00 | $50.00 |
| WINNER | | | WINS | | |

Table 10 shows the results of the second auction after C is removed.

TABLE 10
Winner of the second asset slot under the High Bidder Wins -
All Pay Same Price Per Impression auctioning model.

| | Asset | | | | |
|---|---|---|---|---|---|
| | A | B | C | D | E |
| Total Impressions | 3 | 1 | 0 | 3 | 3 |
| Estimated Audience | 60 | 20 | 0 | 60 | 60 |
| CPI Bid | 0.30 | 0.25 | 0.30 | 0.10 | 0.25 |
| Offering Price (Z) | $18.00 | $5.00 | $— | $6.00 | $15.00 |
| WINNER | WINS | | | | |

Reimburse

The Reimburse auctioning model is one of several improved auctioning models that encourage bidder truth-telling (i.e., encourage bidders to bid their actual individual value for a flotilla slot/asset delivery option) and discourage bid shading (i.e., a situation in which bidders bid less than their respective values) as well as bidder collusion and strategic behavior. These new auction models have also been designed to maximize revenue for sellers within the targeted asset delivery context while promoting the perception of fairness in both the process and the outcome of each auction.

While the auction models may be applied to flotillas with any number of slots, the examples described below include four asset options competing to fill a flotilla having two asset slots and one column (i.e., one parallel content distribution opportunity available in a given avail). Table 11 shows a second scenario, Scenario 2, presenting impression availability or vote tabulation over several UEDs. As shown in Table 11, Scenario 2 includes an asset provider A targeting males ages 25 to 55 with asset A, an asset provider B targeting males ages 18 to 49 with asset B, an asset provider C targeting all females with asset C, and an asset provider D targeting all males with asset D. The rows of Table 11 represent user demographics associated with each UED by gender and age.

Table 11 totals the number of impressions available to each asset provider A-D and multiplies this total with the amount of each provider's submitted bid, or the amount that the asset provider is bidding per impression (CPI bid), to calculate the total payment each asset provider is willing to make for a flotilla slot (the Z value), assuming that the asset provider receives all appropriate users/impressions. For example, asset provider B has three appropriate users (male 18, male 30, and male 20), and since asset provider B has submitted a bid of $0.55 per impression, asset B is willing to pay a total Z value of $1.65 for a flotilla slot, if it receives all three impressions.

TABLE 11
Tabulation of available impressions for Scenario 2.

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | | 1 | | 1 |
| Demographic | Male 50 | 1 | | | 1 |
| (associated | Male 30 | 1 | 1 | | 1 |
| with UED) | Male 55 | 1 | | | 1 |
| | Male 20 | | 1 | | 1 |
| | Female 40 | | | 1 | 0 |

| | | | | |
|---|---|---|---|---|
| Total Impressions | 3 | 3 | 1 | 5 |
| CPI bid | 0.65 | 0.55 | 0.60 | 0.05 |
| Offering Price (Z) | 1.95 | 1.65 | 0.60 | 0.25 |

Turning to the logistics of the Reimburse auctioning model itself, the concept is to charge the winning bidder an amount congruent with the number of users it is “taking away” from other asset providers. First, the winning bidder is determined to be the asset provider with the highest Z value. Then the winning bidder's payment is calculated as follows: For each non-winning asset provider, the sum of its users captured by the winning asset is calculated and multiplied with the respective CPI bid to derive Z′. The winning bidder must pay the highest Z′.

After the winning bidder has been determined, it is removed from the system together with all of the users it captured. Then the process repeats to determine the next winner until all flotilla slots are filled.

Applying the Reimburse auctioning model to the tabulation of available impressions of Scenario 2 (Table 11) shows that the highest Z belongs to asset provider A (Z=$1.95), targeting males 25-55 with asset A. Thus, asset provider A wins the first flotilla slot. Table 12, below, highlights the users that asset provider A is taking away from the other asset providers.

TABLE 12
Users captured from asset providers B, C, and
D after asset provider A wins the first flotilla
slot under the Reimburse auctioning model.

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | | 1 | | 1 |
| Demographic | Male 50 | 1 | | | 1 |
| (associated | Male 30 | 1 | 1 | | 1 |
| with UED) | Male 55 | 1 | | | 1 |
| | Male 20 | | 1 | | 1 |
| | Female 40 | | | 1 | |

| | | | | |
|---|---|---|---|---|
| Users captured | N/A | 1 | 0 | 3 |
| CPI bid | N/A | 0.55 | 0.60 | 0.05 |
| Z′ | N/A | 0.55 | 0.00 | 0.15 |

As shown in Table 12, the respective values for Z′ for asset providers B, C, and D equal $0.55, $0.00, and $0.15. The winning asset provider A is charged the largest Z′, or $0.55, for its three impressions.

Before determining the winner of the second flotilla slot, the table is updated to reflect the users that have been captured by asset provider A in the first auction. Table 13 reflects this new state of the system.

TABLE 13
Second tabulation of available impressions
under the Reimburse auctioning model.

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | N/A | 1 | | 1 |
| Demographic | Male 50 | N/A | | | |
| (associated | Male 30 | N/A | | | |
| with UED) | Male 55 | N/A | | | |
| | Male 20 | N/A | 1 | | 1 |
| | Female 40 | N/A | | 1 | |

| | | | | |
|---|---|---|---|---|
| Updated Total Impressions | N/A | 2 | 1 | 2 |
| CPI Bid | N/A | 0.55 | 0.60 | 0.05 |
| Offering Price (Z) | N/A | 1.10 | 0.60 | 0.10 |

The new highest Z value belongs to asset provider B, targeting mails 18-49 with asset B, having a Z value of $1.10. As with the first winning bidder, asset provider B's payment is determined by calculating the users that it is taking away from the remaining asset providers C and D, as shown in Table 14 below.

TABLE 14
Users captured from asset providers C and D after
asset provider B wins the second flotilla slot.

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | N/A | 1 | | 1 |
| Demographic | Male 50 | N/A | N/A | N/A | N/A |
| (associated | Male 30 | N/A | N/A | N/A | N/A |
| with UED) | Male 55 | N/A | N/A | N/A | N/A |
| | Male 20 | N/A | 1 | | 1 |
| | Female 40 | N/A | | 1 | |

| | | | | |
|---|---|---|---|---|
| Users captured | N/A | N/A | | 2 |
| CPI Bid | N/A | N/A | 0.60 | 0.05 |
| Z′ | N/A | N/A | 0.00 | 0.10 |

The new Z′ values for asset providers C and D are $0.00 and $0.10, respectively. Thus, asset provider B will pay the larger of these two Z′ values, or $0.10, and will receive two impressions. As a result, the Reimburse auctioning model will raise a total of $0.65 ($0.55+$0.10) in revenue for the two-slot flotilla.

MinMax

The MinMax auctioning model is based on a series of mini auctions run for each available impression prior to a global auction that is based upon the mini-auction results. That is, the asset targeting system first determines, for each individual user (i.e., each available impression), which asset provider is willing to pay the most to capture the user (i.e., highest CIP bid for the user) and how much that asset provider is willing to pay. Then the system determines an amount that the asset provider must pay in order to win the user, or an amount equal to the next highest bid for the user from any other asset provider. For each asset provider in the system, these maximum and minimum values are totaled, providing each asset provider with a max total and a min total. If an asset provider does not win any of the mini auctions, then the max total and the min total equal $0.00.

The asset provider with the highest max total wins the first flotilla slot and is charged the greater of its min total and the next highest max total from among the other asset providers. Conceptually, the asset provider must pay at least its own min total because that amount represents an amount required to win the mini auctions, and the asset provider must also pay at least the next highest max total because the next highest max total represents an amount another asset provider is willing to pay to claim the first flotilla slot. After the first flotilla slot has been auctioned, the winning asset provider is removed from the system and the process is repeated until all flotilla slots have been filled.

Table 15 shows the results of auctioning the first flotilla slot according to the MinMax auctioning model as applied to the available impression tabulation for Scenario 2 (Table 11).

TABLE 15
Auctioning the first flotilla slot under the MinMax auctioning model as
applied to the available impression tabulation of Scenario 2 (Table 11).

| | | Asset Providers with Assets Targeting: | | | | | | |
|---|---|---|---|---|---|---|---|---|
| | | A | B | | | | | |
| | | Males | Males | C | D | | | |
| | | 25-55 | 18-49 | Females | Males | Winner | Max | Min |
| User | Male 18 | | 1 | | 1 | B | 0.55 | 0.05 |
| Demographic | Male 50 | 1 | | | 1 | A | 0.65 | 0.05 |
| (associated | Male 30 | 1 | 1 | | 1 | A | 0.65 | 0.55 |
| with UED) | Male 55 | 1 | | | 1 | A | 0.65 | 0.05 |
| | Male 20 | | 1 | | 1 | B | 0.55 | 0.05 |
| | Female 40 | | | 1 | | C | 0.60 | 0 |

| | | | | |
|---|---|---|---|---|
| Total Impressions | 3 | 3 | 1 | 5 |
| CPI Bid | 0.65 | 0.55 | 0.60 | 0.05 |
| Offering Price (Z) | 1.95 | 1.65 | 0.60 | 0.25 |
| Max Total | 1.95 | 1.10 | 0.60 | 0 |
| Min Total | 0.65 | 0.10 | 0 | 0 |

The winners of the mini auctions are determined as shown on the right-hand side of Table 15. For instance, the highest bid for user “male 18” comes from asset provider B with a maximum bid of $0.55. Asset provider B must pay a minimum of $0.05 to beat the next highest (and only other) bid for user “male 18” from asset provider D, equaling $0.05. The bottom of Table 15 presents the max total and the min total for each asset provider. For example, asset provider A won three mini auctions (“male 50,” “male 30,” and “male 55”) with its $0.65 bid per impression. Thus, asset provider A's max total equals $1.95 (3×$0.65), and asset provider A's min total equals $0.65 (2×$0.05+$0.55). Asset provider A wins the first flotilla slot with the highest max total of $1.95. Asset provider A receives three impressions and is charged the greater of its min total and the next highest max total from among the other asset providers B, C, and D (max [$0.65, max {$1.10, $0.60, $0.00}]), or $1.10. Then asset provider A is removed from the system and the calculations are repeated to determine the winner of the second flotilla slot, as shown in Table 16 below.

TABLE 16
Auctioning the second flotilla slot under the MinMax
auctioning model as applied to Scenario 2 (Table 11).

| | | Asset Providers with Assets Targeting: | | | | | | |
|---|---|---|---|---|---|---|---|---|
| | | A | B | | | | | |
| | | Males | Males | C | D | | | |
| | | 25-55 | 18-49 | Females | Males | Winner | Max | Min |
| User | Male 18 | N/A | 1 | | 1 | B | 0.55 | 0.05 |
| Demographic | Male 50 | N/A | N/A | N/A | N/A | N/A | N/A | N/A |
| (associated | Male 30 | N/A | N/A | N/A | N/A | N/A | N/A | N/A |
| with UED) | Male 55 | N/A | N/A | N/A | N/A | N/A | N/A | N/A |
| | Male 20 | N/A | 1 | | 1 | B | 0.55 | 0.05 |
| | Female 40 | N/A | | 1 | | C | 0.60 | 0 |

| | | | | |
|---|---|---|---|---|
| Total Impressions | N/A | 2 | 1 | 2 |
| CPI Bid | N/A | 0.55 | 0.60 | 0.05 |
| Offering Price (Z) | N/A | 1.10 | 0.60 | 0.10 |
| Max Total | N/A | 1.10 | 0.60 | 0 |
| Min Total | N/A | 0.10 | 0 | 0 |

Table 16 shows that asset provider B has the highest max total ($1.10) and, therefore, wins the second flotilla slot. Asset provider B receives two impressions for a price of $0.60 (max [$0.10, max {$0.60, $0.00}]). As a result, the MinMax auctioning model will raise a total of $1.70 ($1.10+$0.60) in revenue for the two-slot flotilla.

Get Each User

The Get Each User auctioning model is inspired by the MinMax auctioning model, but captures the fact that asset providers may be willing to pay more for some users than others, so long as the average cost per impression is equal to or below the asset provider's CPI bid. The system first determines, for each user, a minimum amount that each interested asset provider must pay to win the particular user, which equals the maximum bid among all other asset providers interested in the particular user. These minimums are totaled to calculate a min total for each asset provider. To ensure that asset providers never pay more than their bid amounts, a final min total is calculated for each asset provider by taking the lesser of each asset provider's min total and its Z value. The first flotilla slot goes to the asset provider with the highest Z value, who must pay the maximum of all of the final min totals. Then the winning asset provider is removed and the process is repeated until all flotilla slots have been filled.

TABLE 17
Auctioning the first flotilla slot under the Get Each User
auctioning model as applied to Scenario 2 (Table 11).

| | | Asset Providers with Assets Targeting: | | | | | | | |
|---|---|---|---|---|---|---|---|---|---|
| | | A | B | | | A | B | | |
| | | Males | Males | C | D | Males | Males | C | D |
| | | 25-55 | 18-49 | Females | Males | 25-55 | 18-49 | F | M |
| User | Male 18 | | 1 | | 1 | 0 | 0.05 | 0 | 0.55 |
| Demographic | Male 50 | 1 | | | 1 | 0.05 | 0 | 0 | 0.65 |
| (associated | Male 30 | 1 | 1 | | 1 | 0.55 | 0.65 | 0 | 0.65 |
| with UED) | Male 55 | 1 | | | 1 | 0.05 | 0 | 0 | 0.65 |
| | Male 20 | | 1 | | 1 | 0 | 0.05 | 0 | 0.55 |
| | Female 40 | | | 1 | | 0 | 0 | 0 | 0 |

| | | | | |
|---|---|---|---|---|
| Total Impressions | 3 | 3 | 1 | 5 |
| CPI Bid | 0.65 | 0.55 | 0.60 | 0.05 |
| Offering Price (Z) | 1.95 | 1.65 | 0.60 | 0.25 |
| Min Total | 0.65 | 0.75 | 0 | 3.05 |
| Final Min Total | 0.65 | 0.75 | 0 | 0.25 |

Table 17 applies the Get Each User auction model to the available asset tabulation of Scenario 2 (Table 11). Specifically, the right-hand side of Table 17 shows the minimum amount that each asset provider must pay to win each respective mini auction of interest. For instance, in order to win viewer “male 18,” asset provider B must outbid asset provider D ($0.05), while asset provider D must outbid asset provider B ($0.55). The bottom of Table 17 shows the min totals and the final min totals for each asset provider. For example, to win all three mini auctions of interest, asset provider A must pay $0.05, $0.55, and $0.05 to get the users “male 50,” “male 30,” and “male 55,” respectively, resulting in a min total of $0.65. Because asset provider A's Z value of $1.95 is higher than the min total, asset provider's final min total is $0.65.

In this particular auction, the highest Z value belongs to asset provider A, so asset provider A wins the first flotilla slot and is charged the maximum of all of the final min totals, or $0.75, for its three impressions.

Table 18 illustrates the determination of the winner of the second flotilla slot after asset provider A has been removed from the system.

TABLE 18
Auctioning the second flotilla slot under the Get Each User
auctioning model as applied to Scenario 2 (Table 11).

| | | Asset Providers with Assets Targeting: | | | | | | | |
|---|---|---|---|---|---|---|---|---|---|
| | | A | B | | | A | B | | |
| | | Males | Males | C | D | Males | Males | C | D |
| | | 25-55 | 18-49 | Females | Males | 25-55 | 18-49 | F | M |
| User | Male 18 | N/A | 1 | | 1 | N/A | 0.05 | 0 | 0.55 |
| Demographic | Male 50 | N/A | N/A | N/A | N/A | N/A | N/A | N/A | N/A |
| (associated | Male 30 | N/A | N/A | N/A | N/A | N/A | N/A | N/A | N/A |
| with UED) | Male 55 | N/A | N/A | N/A | N/A | N/A | N/A | N/A | N/A |
| | Male 20 | N/A | 1 | | 1 | N/A | 0.05 | 0 | 0.55 |
| | Female 40 | N/A | | 1 | | N/A | 0 | 0 | 0 |

| | | | | |
|---|---|---|---|---|
| Total Impressions | N/A | 2 | 1 | 2 |
| CPI Bid | N/A | 0.55 | 0.60 | 0.05 |
| Offering Price (Z) | N/A | 1.10 | 0.60 | 0.10 |
| Min Total | N/A | 0.10 | 0 | 1.10 |
| Final Min Total | N/A | 0.10 | 0 | 0.10 |

Here, asset provider B has the highest Z value ($1.10) and, therefore, wins the second flotilla slot. Asset provider B will receive two impressions for the price of $0.10, or the highest of the remaining final min totals. As a result, employing the Get Each User auctioning model results in a total revenue of $0.85 ($0.75+$0.10) for the two-slot flotilla.

3^{rd} CPI

The 3^{rd} CPI auctioning model considers each asset provider's bid per impression without considering the number of expected impressions (i.e., the size of the expected audience). In this regard, the highest value per impression, or CPI bid, wins the first flotilla slot. The second highest CPI bid wins the second flotilla slot, and so on. The flotilla is entirely filled before any payments are determined.

Once all of the flotilla slots are filled, each winning asset provider is charged on a user-by-user basis. That is, for each user that a winning asset provider has captured, the asset provider must pay the maximum of next highest CPI bid among any other asset providers interested in capturing the user and the highest CPI bid among the asset providers that did not make the flotilla. If no other asset provider targeted the user, the winning asset provider must pay the highest CPI bid among the asset providers excluded from the flotilla.

Applying the 3^{rd} CPI auctioning model to the exemplary vote tabulation of Scenario 2 (Table 11) results in the winning asset providers and corresponding payments shown in Table 19 below.

TABLE 19
Auctioning the first and second flotilla slots under the
3^{rd} CPI auctioning model as applied to Scenario 2 (Table 11).

| | | Asset Providers with Assets Targeting: | | | | | |
|---|---|---|---|---|---|---|---|
| | | A | B | | | A | |
| | | Males | Males | C | D | Males | C |
| | | 25-55 | 18-49 | Females | Males | 25-55 | Females |
| User | Male 18 | | 1 | | 1 | 0 | 0 |
| Demographic | Male 50 | 1 | | | 1 | 0.55 | 0 |
| (associated | Male 30 | 1 | 1 | | 1 | 0.55 | 0 |
| with UED) | Male 55 | 1 | | | 1 | 0.55 | 0 |
| | Male 20 | | 1 | | 1 | 0 | 0 |
| | Female 40 | | | 1 | | 0 | 0.55 |

| | | | | | | |
|---|---|---|---|---|---|---|
| Total Impressions | 3 | 3 | 1 | 5 | | |
| CPI Bid | 0.65 | 0.55 | 0.60 | 0.05 | | |
| Offering Price (Z) | 1.95 | 1.65 | 0.60 | 0.25 | 1.65 | 0.55 |

As shown in Table 19, the first flotilla slot goes to the asset provider having the highest CPI bid, or asset provider A with a CPI bid of $0.65. The second flotilla slot goes to the asset provider with the next highest CPI bid, or asset provider C with a CPI bid of $0.60. The right-hand side of Table 19 shows that asset provider A captured three users, users “male 50,” “male 30,” and “male 55.” Because at least one other asset provider wanted each of these users, asset provider A must pay the maximum of next highest CPI bid among any other interested asset providers and the highest CPI bid among the asset providers that did not make the flotilla. Thus, asset provider A must pay $0.55 for each user, for a total of $1.65 for the three impressions. Asset provider C captured user “female 40.” Because no other asset provider targeted “female 40,” asset provider must pay the highest CPI bid of the asset providers excluded from the flotilla, or asset provider B's CPI bid, equaling $0.55. As a result, employing the 3^{rd} CPI auctioning model results in a total revenue of $2.20 ($1.65+$0.55) for the two-slot flotilla for the asset availability tabulation presented in Table 11.

Revision of Reimburse. MinMax and Get Each User

Each of the Reimburse, MinMax, and Get Each User auctioning algorithms may be revised to recognize that the sale of the last flotilla slot has special implications. That is, the asset provider that captures the last flotilla slot does not only seize the particular demographic won from all other asset providers, but instead takes away from all other asset providers the chance to capture any demographic whatsoever. Therefore, in the Revised Reimburse, Revised MinMax, and Revised Get Each User auctioning models (i.e., the auctioning models that account for the estimated audience size), the last flotilla slot may go to the highest remaining Z value for the price of the next highest remaining Z value, regardless of the auctioning model used to sell the other flotilla slots.

Applying this revision within the Reimburse, MinMax, and Get Each User auctioning model contexts does not alter the winners and/or the corresponding payments discussed above with respect to the first flotilla slot auctioned in each of these auctioning models. That is, each of the Revised Reimburse, Revised MinMax, and Revised Get Each User auctioning models would result in asset provider A winning the first flotilla slot for the price of $0.55, $1.10, and $0.75, respectively. However, as shown in Table 20 below, once asset provider A is removed, each of the revised auctioning models would result in the second flotilla slot going to the asset provider having the highest Z value, or asset provider B with a Z of $1.20. Asset provider B would pay the next highest Z value of $0.60 for the two impressions won. Thus, the Revised Reimburse auctioning model would result in a revenue of $1.15 ($0.55+$0.60) for the two-slot flotilla, while the Revised MinMax model would result in a revenue of $1.70 ($1.10+$0.60) and the Revised Get Each User model would result in a revenue of $1.35 ($0.75+$0.60).

TABLE 20
Auctioning the second flotilla slot under the Revised
Reimburse, Revised MinMax, or Revised Get Each User auctioning
models as applied to Scenario 2 (Table 11).

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | N/A | 1 | | 1 |
| Demographic | Male 50 | N/A | N/A | N/A | N/A |
| (associated | Male 30 | N/A | N/A | N/A | N/A |
| with UED) | Male 55 | N/A | N/A | N/A | N/A |
| | Male 20 | N/A | 1 | | 1 |
| | Female 40 | N/A | | 1 | |

| | | | | |
|---|---|---|---|---|
| Updated Total Impressions | N/A | 2 | 1 | 2 |
| CPI Bid | N/A | 0.60 | 0.60 | 0.05 |
| Offering Price (Z) | N/A | 1.20 | 0.60 | 0.10 |

Reservation Pricing

Revenue may be increased further through an appropriate reservation price, which prevents all asset providers with CPI bids below the reservation price from participating in the auction. Using this model, the winning bidder determination remains the same as described in any of the auctioning models discussed above, but the payment calculations involve an additional step: Once each winning bidder's payment has been calculated according to any of the auctioning models discussed above, the actual payment due equals the maximum between the previously calculated payment and the payment required to satisfy the reservation price per impression. Thus, the seller is guaranteed to receive at least the reservation price per impression, but if the auctioning model price calculation results in an even higher payment, the seller receives that higher amount.

Table 21, below, shows a series of sample reservation prices in the bottom row. Each reservation price corresponds to a particular targeted demographic. For instance, asset provider A is targeting males 25-55, and the reservation price per impression for that demographic is $0.50.

TABLE 21
Use of reservation prices.

| | | Asset Providers with Assets Targeting: | | | |
|---|---|---|---|---|---|
| | | A | B | | |
| | | Males | Males | C | D |
| | | 25-55 | 18-49 | Females | Males |
| User | Male 18 | | 1 | | 1 |
| Demographic | Male 50 | 1 | | | 1 |
| (associated | Male 30 | 1 | 1 | | 1 |
| with UED) | Male 55 | 1 | | | 1 |
| | Male 20 | | 1 | | 1 |
| | Female 40 | | | 1 | |

| | | | | |
|---|---|---|---|---|
| Total Impressions | 3 | 3 | 1 | 5 |
| CPI Bid | 0.65 | 0.55 | 0.60 | 0.05 |
| Offering Price (Z) | 1.95 | 1.65 | 0.60 | 0.25 |
| Reservation Price | 0.50 | 0.40 | 0.30 | 0.30 |

Using the reservation prices shown in Table 21, asset provider D would not participate in the auction because its submitted bid per impression, or CPI bid, is below the reservation price for its targeted demographic. Further, some of the auctioning models discussed above would result in a lower price per impression than the reservation price and, as a result, the winners would be charged the higher reservation price. For instance, as discussed above, the winner of the first flotilla slot under the Reimburse auctioning model is asset provider A. Under the Reimburse auctioning model, asset provider A would be required to pay $0.55 for its three impressions. Because the reservation price per impression results in a greater amount for the three impressions (3×$0.50=$1.50), asset provider A would be charged $1.50 instead of $0.55.

The preceding auction discussions assume only one parallel distribution alternative within an avail (break). In general, there will be more than one. A separate auction should be run for each flotilla column, although it should be noted that the pool of votes may need to be updated for the subsequent breaks after an asset is placed (minimum separation rules will usually prevent the same asset from being delivered twice in a row). Commodity code rules may also make some assets “illegal” after another asset has been placed. One way to run an auction is to sell the contents of each column in a sequential fashion. However, an alternative mechanism is to sequentially auction all of the first positions in each column, then auction the second positions proceeding in this fashion until all positions have been sold.

Considerable historical information about auctions accumulates quickly. This information can be used to assist a bidder in making its bids. For instance, historical information about all previous campaigns that match the targeting of a newly created campaign can be retrieved. This information can suggest the average number of impressions that are available for a given type of campaign on a daily basis (as well as the total number of impressions that are available on a daily basis). Average cost per impression for similar campaigns can also be retrieved. Aggregate information about current campaigns can also be retrieved and the demand for impressions can be calculated. This demand can be compared with the historical demand and prices to produce a rough estimate of what current prices are likely to be.

When a bidder is entering a new campaign, it may request (e.g., via an interface) the system to provide historical information and/or estimates of prices and available impressions. This information could then guide the bidder in the number of impressions that it is likely able to get over a given time period and suggest a bidding range that would likely get the bidder that amount of impressions. Of course, the system can only provide estimates since external forces may increase demand unexpectedly, supply may reduce, or any number of factors may invalidate the estimate. For this reason it may be important that asset providers be able to update their bidding parameters as their campaigns progress. In addition, because of the dynamic nature of the auctioning process, a final check may be built into the auctioning system to verify the availability of the asset for insertion. If the winning asset is unavailable, this may trigger a reauction or a selection of a new winner from the previous auction.

C. Campaign Monitoring

While a particular campaign is active for a bidder several pieces of information can be made available to them.

Examples of available information include: (1) cumulative count of impressions for the campaign; (2) daily, weekly and monthly impression counts for the campaign since it started and, if appropriate, a comparison to goals associated with pacing budget; (3) current status of the budget, both spent and remaining funds, and similar status for pacing budgets; (4) daily, weekly and monthly total costs for the campaign since it started and, if appropriate, a comparison to pacing budgets; (5) detailed information about all auctions won; (6) detailed information about auctions that were lost, including some information about the winning bids (estimates audience sizes and impression costs); (7) average number of total impressions delivered by the system per day, week and month; (8) detailed day-by-day, week-by-week and month-by-month total impressions delivered by the system; (9) average number of total impressions delivered by the system per day, week and month for commonly purchased targets. For instance, the most commonly bought age and gender targets or most commonly purchased geographic areas; and (10) detailed day-by-day, week-by-week and month-by-month total impressions delivered by the system for commonly purchased targets.

The information provided to bidders can be delivered in a number of different formats. Some of these formats, such as tabulation, spreadsheets, and graphs, may be more appropriate for some kinds of data over others.

There are also numerous different ways in which data may be delivered to winning bidders by the system. Some of these mechanisms include users accessing data interactively via the internet using a web browser. This manner of interactive access would allow users to search for specific historical data if it is useful to them. Users can also receive periodic email messages that summarize the status of their campaign. One manner in which these reports can be made available is to provide a menu of standard report types that a user can request be emailed to them. Of course an option that provides for fully customized reports can also be supported. Users can also request that periodic fax summaries be sent to them. Further, users can request that periodic paper reports be mailed to them. Some buyers may be competing with several different campaigns at once. Additional summary information that presents the overall status of all, or various subsets, of their active campaigns can be summarized and made available to them.

While various embodiments of the present invention have been described in detail, further modifications and adaptations of the invention may occur to those skilled in the art. However, it is to be expressly understood that such modifications and adaptations are within the spirit and scope of the present invention.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A system for auctioning asset delivery options in a broadcast network, the broadcast network primarily involving synchronized distribution of broadcast content to an aggregate audience of target users, said system comprising:
a traffic interface for receiving information regarding said aggregate audience, wherein said information comprises one or more classification parameters associated with each said target user of said aggregate audience;
a user interface for receiving, from each of a plurality of asset providers, an identification of at least one asset for distribution within said broadcast network, one or more targeting parameters associated with each said asset, and a value per impression for one or more segments of said aggregate audience, wherein each said classification parameter and each said targeting parameter identifies one of said segments of said aggregate audience; and
a processor, said processor having logic for:
determining, from a set of defined auctioning models, a first auctioning model for auctioning a first asset delivery option and a second auctioning model for auctioning a second asset delivery option; and
auctioning said first asset delivery option via said first auctioning model and said second asset delivery option via said second auctioning model.

2. A system as set forth in claim 1, wherein said first and second auctioning models are the same.

3. A system as set forth in claim 1, wherein said auctioning said first asset delivery option via said first auctioning model or said second asset delivery option via said second auctioning model results in a maximum revenue for a seller.

4. A system as set forth in claim 1, wherein said logic is configured to determine said first auctioning model based on an analysis of a first subset of a plurality of environmental auctioning factors and said second auctioning model based on an analysis of a second subset of said environmental auctioning factors.

5. A system as set forth in claim 4, wherein said first and second subsets each comprise one or more of said environmental auctioning factors.

6. A system as set forth in claim 4, wherein said first subset differs from said second subset.

7. A system as set forth in claim 4, wherein said environmental factors include a number of said assets competing for said first and second asset delivery options, a size of said aggregate audience, a number of available asset delivery options, a variance between said values per impression, an execution time for said auctioning, an ease of explanation of each said defined auctioning model, and an identity of said asset providers.

8. A system as set forth in claim 1, wherein said determining and said auctioning collectively comprise:
first determining said first auctioning model for auctioning said first asset delivery option based on an analysis of a first subset of a plurality of environmental auctioning factors;
first auctioning said first asset delivery option via said first auctioning model, wherein said first auctioning establishes a first winning asset;
removing one or more of said target users captured by said first winning asset from said aggregate audience;
second determining said second auctioning model for auctioning said second asset delivery option based on an analysis of a second subset of said environmental auctioning factors; and
second auctioning said second asset delivery option via said second auctioning model, wherein said second auctioning establishes a second winning asset.

9. A system as set forth in claim 8, wherein said first and second subsets each comprise one or more of said environmental auctioning factors.

10. A system as set forth in claim 8, wherein said first subset differs from said second subset.

11. A system as set forth in claim 8, wherein said environmental factors include a number of assets competing for said first and second asset delivery options, a size of said aggregate audience, a number of available asset delivery options, a variance between said values per impression, an execution time for said auctioning, an ease of explanation of each said defined auctioning model, and an identity of said asset providers.

12. A system as set forth in claim 8, wherein said logic is configured for analyzing, prior to one of said first determining and said second determining, one or more asset delivery constraints in constructing a pool of said assets available for delivery.

13. A system as set forth in claim 12, wherein each said asset delivery constraint comprises one of a legal constraint, a contractual constraint, and a policy constraint.

14. A system as set forth in claim 1, wherein said logic is configured to determine said first and second auctioning models based on a number of assets competing for said first and second asset delivery options.

15. A system as set forth in claim 1, wherein said logic is configured to determine said first and second auctioning models based on a size of said aggregate audience.

16. A system as set forth in claim 1, wherein said logic is configured to determine said first and second auctioning models based on a number of available asset delivery options.

17. A system as set forth in claim 1, wherein said logic is configured to determine said first and second auctioning models based on a variance between said values per impression.

18. A system as set forth in claim 1, wherein said logic is configured to determine said first and second auctioning models based on an execution time for said auctioning.

19. A system as set forth in claim 1, wherein said logic is configured to determine said first and second auctioning models based on an identity one or more of said asset providers.

20. A system as set forth in claim 1, wherein said logic is configured to determine said first and second auctioning models based on an assessment of an ease of explanation of each said defined auctioning model.

21. A method for use with a computer-based system for auctioning asset delivery options in a broadcast network, the broadcast network primarily involving synchronized distribution of broadcast content to multiple target users, the method comprising:
identifying first and second asset delivery options for delivering content, wherein said first and second asset delivery options are part of a single asset delivery opportunity;
providing, via said computer-based auctioning system, information regarding said first and second asset delivery options to one or more asset providers;
receiving from one or more of said asset providers, via said computer-based auctioning system, bids associated with said first and second asset delivery options; and
executing logic, in connection with said computer-based auctioning system, for:
determining, from a set of defined auctioning models, a first auctioning model for auctioning a first asset delivery option and a second auctioning model for auctioning a second asset delivery option; and
auctioning said first asset delivery option using said first auctioning model and said second asset delivery option via said second auctioning model.

22. A method as set forth in claim 21, wherein said first and second auctioning models are the same.

23. A method as set forth in claim 21, wherein said auctioning of said first asset delivery option using said first auctioning model or said second asset delivery option using said second auctioning model results in a maximum revenue for a seller.

24. A method as set forth in claim 21, wherein said determining comprises analyzing a first subset of a plurality of environmental auctioning factors to select said first auctioning model and analyzing a second subset of said environmental auctioning factors to select said second auctioning model.

25. A method as set forth in claim 24, wherein said first and second subsets each comprise one or more of said environmental auctioning factors.

26. A method as set forth in claim 24, wherein said first subset differs from said second subset.

27. A method as set forth in claim 24, wherein said environmental auctioning factors include a number of assets competing for said first and second asset delivery options, a size of said aggregate audience, a number of available asset delivery options, a variance between said bids, an execution time for said auctioning, and an identity of said asset providers.

28. A method as set forth in claim 21, wherein said determining and said auctioning collectively comprise:
first determining said first auctioning model for auctioning said first asset delivery option based on an analysis of a first subset of a plurality of environmental auctioning factors;
first auctioning said first asset delivery option via said first auctioning model, wherein said first auctioning establishes a first winning asset;
removing one or more of said target users captured by said first winning asset from said aggregate audience;
second determining said second auctioning model for auctioning said second asset delivery option based on an analysis of a second subset of said environmental auctioning factors; and
second auctioning said second asset delivery option via said second auctioning model, wherein said second auctioning establishes a second winning asset.

29. A method as set forth in claim 28, wherein said first and second subsets each comprise one or more of said environmental auctioning factors.

30. A method as set forth in claim 28, wherein said first subset differs from said second subset.

31. A method as set forth in claim 28, wherein said environmental auctioning factors include a number of assets competing for said first and second asset delivery options, a size of said aggregate audience, a number of available asset delivery options, a variance between said bids, an execution time for said auctioning, and an identity of said asset providers.

32. A method as set forth in claim 28, further comprising analyzing, prior to one of said first determining and said second determining, one or more asset delivery constraints in constructing a pool of said assets available for delivery.

33. A method for use with a computer-based system for auctioning assets to target users of a broadcast network, the broadcast network primarily involving synchronized distribution of broadcast content to an aggregate audience of said target users, the method comprising:
providing, via said computer-based auctioning system, information regarding one or more asset delivery options for delivering content to said aggregate audience, wherein said aggregate audience comprises a plurality of at least partially overlapping segments;
receiving, via said computer-based auctioning system, bids associated with said asset delivery options from one or more asset providers, wherein each of said bids comprises a value per impression for one of said segments of said aggregate audience;
running, via said computer-based auctioning system, a sub-auction for each of a plurality of factions within said aggregate audience, wherein each of said factions comprises a smaller fractional portion of said aggregate audience than does each of said segments;
determining, via said computer-based auctioning system, a winning bid, wherein said winning bid is based on a collective outcome of each of said sub-auctions; and
based on said winning bid, selecting an asset associated with said winning bid for insertion into a content stream of said broadcast network for delivery during said asset delivery option.

34. The method of claim 33, wherein each of said segments of said aggregate audience is based on one or more audience characteristics.

35. The method of claim 34, wherein said audience characteristics relate to at least one of age, gender, ethnicity, income, and geographic locale.

36. The method of claim 33, wherein each of said factions comprises one of said target users within said aggregate audience.

37. The method of claim 33, further comprising determining, via said computer-based auctioning system, a sub-winning bid for each of said sub-auctions.

38. The method of claim 37, wherein said winning bid is based on a maximum total of said sub-winning bids from each of said asset providers.

39. The method of claim 33, further comprising determining, via said computer-based auctioning system, a payment to be made in connection with said winning bid, wherein said payment is based at least in part on one or more non-winning bids and a measurement of a size of said aggregate audience.

40. The method of claim 39, wherein said payment is based at least in part on an amount that one or more non-winning asset providers are willing to pay to have said winning bid.

41. The method of claim 39, wherein said payment is based at least in part on the greatest of a minimum total that a winning asset provider must pay to retain said winning bid and a maximum total that a first non-winning asset provider is willing to pay to replace said winning bid.

42. The method of claim 39, wherein said payment is based at least in part on a minimum of a minimum total that a winning asset provider must pay to retain said winning bid and a total offering price of said winning asset provider.

43. The method of claim 39, further comprising removing, via said computer-based auctioning system, each of said factions encompassed within said winning bid from said aggregate audience.

44. The method of claim 43, further comprising repeating said steps of running said sub-auctions, determining said winning bid, determining said payment to be made in connection with said winning bid, selecting said asset associated with said winning bid for insertion into said content stream, and removing each of said factions encompassed within said winning bid until a final asset is selected for insertion into said content stream of said broadcast network.

45. The method of claim 44, wherein said winning bid and said payment associated with said winning bid for said final asset are determined using a revised auction model.

46. The method of claim 33, further comprising determining, via said computer-based auctioning system, a payment to be made in connection with said winning bid, wherein said payment is at least equal to a reservation price.

47. A method for use with a computer-based system for auctioning assets to target users of a broadcast network, the broadcast network primarily involving synchronized distribution of broadcast content to an aggregate audience of said target users, the method comprising:
providing, via said computer-based auctioning system, information regarding one or more asset delivery options for delivering content to said aggregate audience, wherein said aggregate audience comprises a plurality of at least partially overlapping segments;
receiving, via said computer-based auctioning system, bids associated with said asset delivery options from one or more asset providers, wherein each of said bids comprises a value per impression for one of said segments of said aggregate audience;
first determining, via said computer-based auctioning system, a winning bid from among said bids; and
second determining, via said computer-based auctioning system, a payment to be made in connection with said winning bid, wherein said payment is based at least in part on one or more non-winning bids and a measurement of a size of at least a portion of an audience segment.

48. The method of claim 47, wherein each said segment is based on one or more audience characteristics.

49. The method of claim 48, wherein said audience characteristics relate to at least one of age, gender, ethnicity, income, and geographic locale.

50. The method of claim 47, wherein said payment is based on a number of impressions that said winning bid garners from one or more non-winning bids.

51. The method of claim 47, wherein said payment is based at least in part on an amount that one or more non-winning asset providers are willing to pay to have said winning bid.

52. The method of claim 47, further comprising removing, via said computer-based auctioning system, each of said impressions encompassed within said winning bid from said aggregate audience.

53. The method of claim 52, further comprising repeating said steps of first determining said winning bid, second determining said payment to be made in connection with said winning bid, and removing each of said impressions encompassed within said winning bid until a final asset is selected for insertion into said content stream of said broadcast network.

54. The method of claim 53, wherein said winning bid and said payment associated with said winning bid for said final asset are determined using a revised auction model.

55. The method of claim 47, wherein said payment is at least equal to a reservation price.

56. A method for use with a computer-based system for auctioning assets to target users of a broadcast network, the broadcast network primarily involving synchronized distribution of broadcast content to an aggregate audience of said target users, the method comprising:
providing, via said computer-based auctioning system, information regarding first and second asset delivery options for delivering content to said aggregate audience, wherein said aggregate audience comprises a plurality of at least partially overlapping segments;
receiving from one or more asset providers, via said computer-based auctioning system, bids associated with said first and second asset delivery options, wherein each said bid comprises a value per impression for one of said segments of said aggregate audience;
first determining, via said computer-based auctioning system, a first winning bid for said first asset delivery option and a second winning bid for said second asset delivery option a from among said bids; and
second determining, via said computer-based auctioning system, first and second payments to be made in connection with said first and second winning bids, respectively, wherein said first payment is based at least in part on an amount that any of said asset providers is willing to pay to have said first winning bid and an amount that one or more non-winning asset providers are willing to pay to have one of said first and second winning bids.

57. A method as set forth in claim 56, wherein said second payment is based at least in part on an amount that any of said asset providers is willing to pay to have said second winning bid and an amount that one or more of said non-winning asset providers are willing to pay to have one of said first and second winning bids.

58. A method for use with a computer-based system for auctioning assets to target users of a broadcast network, the broadcast network primarily involving synchronized distribution of broadcast content to an aggregate audience of target users, the method comprising:
receiving, via said computer-based auctioning system, a first bid for a first segment of said aggregate audience;
receiving, via said computer-based auctioning system, a second bid for a second segment of said aggregate audience, wherein said first and second segments each comprise one or more overlapping portions; and
considering said overlapping portions, determining, via said computer-based auctioning system, a winning bid and a payment to be made in connection with said winning bid to maximize revenue.
